(19) United States
(12) Patent Application Publication
(10) Pub. No.: US 2026/0353307 A1
(43) Pub. Date: Nov. 5, 2026

(54) INTERFERENCE MITIGATION SIGNALING TECHNIQUES FOR A PHYSICAL LAYER PROTOCOL DATA UNIT

(71) Applicant: QUALCOMM Incorporated, San Diego, CA (US)

(72) Inventors: Eugene BAIK, Sunnyvale, CA (US); Jialing Li CHEN, San Diego, CA (US); Bin TIAN, San Diego, CA (US); Youhan KIM, Saratoga, CA (US)

(21) Appl. No.: 19/197,885

(22) Filed: May 2, 2025

(51) Int. Cl. H04W 52/32; H04L 1/00; H04W 52/24

(52) U.S. Cl. CPC H04W 52/325; H04L 1/0008; H04W 52/243

(57) ABSTRACT

This disclosure provides methods, components, devices and systems for interference mitigation (IM) signaling techniques for a physical layer protocol data unit (PPDU). Some aspects more specifically relate to power scaling data tones of a data portion of the PPDU based on pilot tones having a null-toned value during the IM mode. Some other aspects relate to capability signaling for IM, and more specifically relate to signaling a threshold quantity of spatial streams supported by a wireless device for communication of a PPDU in which the IM mode is set to an ON state. Some other aspects more specifically relate to packet extensions (PEs) for PPDUs in which the IM mode is set to the ON state. Some other aspects more specifically relate to interleaving pilot tones with data tones in a data portion of a PPDU in which the IM mode is set to an ON state.

### TECHNICAL FIELD

This disclosure relates generally to wireless communication and, more specifically, to interference mitigation (IM) signaling techniques for a physical (PHY) layer protocol data unit (PPDU).

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

In some wireless communication systems, two or more wireless communication devices may support an interference mitigation (IM) mode. An IM mode may enable a wireless communication device to measure or otherwise ascertain information associated with interference experienced at the wireless communication device. For example, in accordance with the IM mode, a first wireless communication device may allocate pilot tone subcarriers within one or more orthogonal frequency division multiplexing (OFDM) symbols of a data field of a physical layer (PHY) protocol data unit (PPDU). In such examples, a second wireless communication device may receive the PPDU and process the data field of the PPDU, such that the second wireless communication device uses the pilot tone subcarriers to measure or otherwise ascertain information associated with interference experienced by the second wireless communication device.

### SUMMARY

The systems, methods, and devices of this disclosure each have several innovative aspects, no single one of which is solely responsible for the desirable attributes disclosed herein.

A method for wireless communication by a wireless communication device is described. The method may include communicating information indicative of an ON state of an interference mitigation (IM) mode for a physical layer protocol data unit (PPDU), the PPDU including a preamble portion and a data portion and transmitting the PPDU, one or more fields of the preamble portion being transmitted via a set of multiple tones according to a first per-tone transmit power, and the data portion being transmitted according to a resource unit (RU) that includes: a set of multiple pilot tones for IM corresponding to the IM mode, the set of multiple pilot tones corresponding to a null-tone value, and a set of multiple data tones interleaved with the set of multiple pilot tones within the RU, the data portion being transmitted via the set of multiple data tones according to a second per-tone transmit power, the second per-tone transmit power being greater than the first per-tone transmit power in accordance with the set of multiple pilot tones corresponding to the null-tone value.

A wireless communication device for wireless communication is described. The wireless communication device may include a processing system that includes processor circuitry and memory circuitry that stores code. The processing system may be configured to cause the wireless communication device to communicate information indicative of an ON state of an IM mode for a PPDU, the PPDU including a preamble portion and a data portion and transmit the PPDU, one or more fields of the preamble portion being transmitted via a set of multiple tones according to a first per-tone transmit power, and the data portion being transmitted according to a RU that includes: a set of multiple pilot tones for IM corresponding to the IM mode, the set of multiple pilot tones corresponding to a null-tone value, and a set of multiple data tones interleaved with the set of multiple pilot tones within the RU, the data portion being transmitted via the set of multiple data tones according to a second per-tone transmit power, the second per-tone transmit power being greater than the first per-tone transmit power in accordance with the set of multiple pilot tones corresponding to the null-tone value.

Another wireless communication device for wireless communication is described. The wireless communication device may include means for communicating information indicative of an ON state of an IM mode for a PPDU, the PPDU including a preamble portion and a data portion and means for transmitting the PPDU, one or more fields of the preamble portion being transmitted via a set of multiple tones according to a first per-tone transmit power, and the data portion being transmitted according to a RU that includes: a set of multiple pilot tones for IM corresponding to the IM mode, the set of multiple pilot tones corresponding to a null-tone value, and a set of multiple data tones interleaved with the set of multiple pilot tones within the RU, the data portion being transmitted via the set of multiple data tones according to a second per-tone transmit power, the second per-tone transmit power being greater than the first per-tone transmit power in accordance with the set of multiple pilot tones corresponding to the null-tone value.

A non-transitory computer-readable medium storing code for wireless communication is described. The code may include instructions executable by one or more processors to communicate information indicative of an ON state of an IM mode for a PPDU, the PPDU including a preamble portion and a data portion and transmit the PPDU, one or more fields of the preamble portion being transmitted via a set of multiple tones according to a first per-tone transmit power, and the data portion being transmitted according to a RU that includes: a set of multiple pilot tones for IM corresponding to the IM mode, the set of multiple pilot tones corresponding to a null-tone value, and a set of multiple data tones interleaved with the set of multiple pilot tones within the RU, the data portion being transmitted via the set of multiple data tones according to a second per-tone transmit power, the second per-tone transmit power being greater than the first per-tone transmit power in accordance with the set of multiple pilot tones corresponding to the null-tone value.

In some examples of the method, wireless communication devices, and non-transitory computer-readable medium described herein, the preamble portion of the PPDU includes a long training field (LTF) and the method, apparatuses, and non-transitory computer-readable medium may include further operations, features, means, or instructions for transmitting the LTF via a first subset of the set of multiple tones according to the second per-tone transmit power, where a second subset of tones of the set of multiple tones correspond to the null-tone value over symbols for transmission of the LTF, and where a respective tone of the second subset of tones correspond to a respective tone of the set of multiple pilot tones.

In some examples of the method, wireless communication devices, and non-transitory computer-readable medium described herein, the preamble portion of the PPDU includes an LTF and the method, apparatuses, and non-transitory computer-readable medium may include further operations, features, means, or instructions for transmitting the LTF via the set of multiple tones according to the second per-tone transmit power in accordance with the set of multiple pilot tones corresponding to the null-tone value.

Another method for wireless communication by a wireless communication device is described. The method may include receiving first information indicative of a threshold quantity of spatial streams for communications of PPDUs in which an IM mode is set to an ON state, communicating second information indicative of the ON state of the IM mode for a PPDU, and transmitting the PPDU via a quantity of spatial streams that is less than or equal to the threshold quantity of spatial streams, the PPDU including a data portion that is transmitted according to a RU that includes: a set of multiple pilot tones for IM corresponding to the IM mode, and a set of multiple data tones interleaved with the set of multiple pilot tones within the RU.

Another wireless communication device for wireless communication is described. The wireless communication device may include a processing system that includes processor circuitry and memory circuitry that stores code. The processing system may be configured to cause the wireless communication device to receive first information indicative of a threshold quantity of spatial streams for communications of PPDUs in which an IM mode is set to an ON state, communicate second information indicative of the ON state of the IM mode for a PPDU, and transmit the PPDU via a quantity of spatial streams that is less than or equal to the threshold quantity of spatial streams, the PPDU including a data portion that is transmitted according to a RU that includes: a set of multiple pilot tones for IM corresponding to the IM mode, and a set of multiple data tones interleaved with the set of multiple pilot tones within the RU.

Another wireless communication device for wireless communication is described. The wireless communication device may include means for receiving first information indicative of a threshold quantity of spatial streams for communications of PPDUs in which an IM mode is set to an ON state, means for communicating second information indicative of the ON state of the IM mode for a PPDU, and means for transmitting the PPDU via a quantity of spatial streams that is less than or equal to the threshold quantity of spatial streams, the PPDU including a data portion that is transmitted according to a RU that includes: a set of multiple pilot tones for IM corresponding to the IM mode, and a set of multiple data tones interleaved with the set of multiple pilot tones within the RU.

Another non-transitory computer-readable medium storing code for wireless communication is described. The code may include instructions executable by one or more processors to receive first information indicative of a threshold quantity of spatial streams for communications of PPDUs in which an IM mode is set to an ON state, communicate second information indicative of the ON state of the IM mode for a PPDU, and transmit the PPDU via a quantity of spatial streams that is less than or equal to the threshold quantity of spatial streams, the PPDU including a data portion that is transmitted according to a RU that includes: a set of multiple pilot tones for IM corresponding to the IM mode, and a set of multiple data tones interleaved with the set of multiple pilot tones within the RU.

In some examples of the method, wireless communication devices, and non-transitory computer-readable medium described herein, the first information may be transmitted via an ultra-high reliability (UHR) physical capabilities information element of a management frame.

In some examples of the method, wireless communication devices, and non-transitory computer-readable medium described herein, the first information may be transmitted via a bit field of the UHR physical capabilities information element.

Another method for wireless communication by a wireless communication device is described. The method may include communicating information indicative of an ON state of an IM mode for a PPDU, receiving a preamble portion of the PPDU, the preamble portion of the PPDU indicative of packet extension (PE) being applied to a data portion of the PPDU, the data portion of the PPDU including a set of data bits followed by a set of padding bits in accordance with the PE, and receiving the data portion of the PPDU via a set of symbols that is in accordance with the PE, the set of data bits being received via a first subset of the set of symbols and the set of padding bits being received via a second subset of the set of symbols, a quantity of the second subset of the set of symbols being in accordance with a PE duration and a quantity of padding symbols utilized for the PE and the IM mode.

Another wireless communication device for wireless communication is described. The wireless communication device may include a processing system that includes processor circuitry and memory circuitry that stores code. The processing system may be configured to cause the wireless communication device to communicate information indicative of an ON state of an IM mode for a PPDU, receive a preamble portion of the PPDU, the preamble portion of the PPDU indicative of PE being applied to a data portion of the PPDU, the data portion of the PPDU including a set of data bits followed by a set of padding bits in accordance with the PE, and receive the data portion of the PPDU via a set of symbols that is in accordance with the PE, the set of data bits being received via a first subset of the set of symbols and the set of padding bits being received via a second subset of the set of symbols, a quantity of the second subset of the set of symbols being in accordance with a PE duration and a quantity of padding symbols utilized for the PE and the IM mode.

Another wireless communication device for wireless communication is described. The wireless communication device may include means for communicating information indicative of an ON state of an IM mode for a PPDU, means for receiving a preamble portion of the PPDU, the preamble portion of the PPDU indicative of PE being applied to a data portion of the PPDU, the data portion of the PPDU including a set of data bits followed by a set of padding bits in accordance with the PE, and means for receiving the data portion of the PPDU via a set of symbols that is in accordance with the PE, the set of data bits being received via a first subset of the set of symbols and the set of padding bits being received via a second subset of the set of symbols, a quantity of the second subset of the set of symbols being in accordance with a PE duration and a quantity of padding symbols utilized for the PE and the IM mode.

Another non-transitory computer-readable medium storing code for wireless communication is described. The code may include instructions executable by one or more processors to communicate information indicative of an ON state of an IM mode for a PPDU, receive a preamble portion of the PPDU, the preamble portion of the PPDU indicative of PE being applied to a data portion of the PPDU, the data portion of the PPDU including a set of data bits followed by a set of padding bits in accordance with the PE, and receive the data portion of the PPDU via a set of symbols that is in accordance with the PE, the set of data bits being received via a first subset of the set of symbols and the set of padding bits being received via a second subset of the set of symbols, a quantity of the second subset of the set of symbols being in accordance with a PE duration and a quantity of padding symbols utilized for the PE and the IM mode.

In some examples of the method, wireless communication devices, and non-transitory computer-readable medium described herein, a quantity of the first subset of the set of symbols may be in accordance with an intermediate quantity of data symbols and the quantity of padding symbols, and the quantity of the second subset of the set of symbols may be in accordance with the PE duration, the quantity of padding symbols, a guard interval length between each symbol of the set of symbols, and a length of a symbol.

In some examples of the method, wireless communication devices, and non-transitory computer-readable medium described herein, the preamble portion of the PPDU indicates a set of parameters including one or more of the guard interval length, a length of the data portion, or a padding factor and the intermediate quantity of data symbols, the quantity of padding symbols, or both may be calculated in accordance with the set of parameters.

Another method for wireless communication by a wireless communication device is described. The method may include communicating first information indicative of an ON state of an IM mode for a PPDU, the PPDU including a preamble portion and a data portion, transmitting the preamble portion of the PPDU, the preamble portion indicative of an identifier of a basic service set (BSS) within which the wireless communication device operates, and transmitting the data portion of the PPDU according to a RU that includes: a set of multiple data tones, and a set of multiple pilot tones for IM corresponding to the IM mode, the set of multiple pilot tones interleaved with the set of multiple data tones within the RU in accordance with at least the identifier of the BSS and a tone mapping distance that is in accordance with a size of the RU.

Another wireless communication device for wireless communication is described. The wireless communication device may include a processing system that includes processor circuitry and memory circuitry that stores code. The processing system may be configured to cause the wireless communication device to communicate first information indicative of an ON state of an IM mode for a PPDU, the PPDU including a preamble portion and a data portion, transmit the preamble portion of the PPDU, the preamble portion indicative of an identifier of a BSS within which the wireless communication device operates, and transmit the data portion of the PPDU according to a RU that includes: a set of multiple data tones, and a set of multiple pilot tones for IM corresponding to the IM mode, the set of multiple pilot tones interleaved with the set of multiple data tones within the RU in accordance with at least the identifier of the BSS and a tone mapping distance that is in accordance with a size of the RU.

Another wireless communication device for wireless communication is described. The wireless communication device may include means for communicating first information indicative of an ON state of an IM mode for a PPDU, the PPDU including a preamble portion and a data portion, means for transmitting the preamble portion of the PPDU, the preamble portion indicative of an identifier of a BSS within which the wireless communication device operates, and means for transmitting the data portion of the PPDU according to a RU that includes: a set of multiple data tones, and a set of multiple pilot tones for IM corresponding to the IM mode, the set of multiple pilot tones interleaved with the set of multiple data tones within the RU in accordance with at least the identifier of the BSS and a tone mapping distance that is in accordance with a size of the RU.

Another non-transitory computer-readable medium storing code for wireless communication is described. The code may include instructions executable by one or more processors to communicate first information indicative of an ON state of an IM mode for a PPDU, the PPDU including a preamble portion and a data portion, transmit the preamble portion of the PPDU, the preamble portion indicative of an identifier of a BSS within which the wireless communication device operates, and transmit the data portion of the PPDU according to a RU that includes: a set of multiple data tones, and a set of multiple pilot tones for IM corresponding to the IM mode, the set of multiple pilot tones interleaved with the set of multiple data tones within the RU in accordance with at least the identifier of the BSS and a tone mapping distance that is in accordance with a size of the RU.

In some examples of the method, wireless communication devices, and non-transitory computer-readable medium described herein, to interleave the set of multiple pilot tones with the set of multiple data tones, elements of an input vector of an interleaver of the wireless communication device may be shifted by a value that may be in accordance with the identifier of the BSS, the tone mapping distance, and a length of the input vector, the input vector including the set of multiple pilot tones and the set of multiple data tones.

In some examples of the method, wireless communication devices, and non-transitory computer-readable medium described herein, to interleave the set of multiple pilot tones with the set of multiple data tones, elements of an output vector of an interleaver of the wireless communication device may be shifted by a value that may be in accordance with the identifier of the BSS modulo the tone mapping distance, the output vector including a first iteration of the set of multiple pilot tones being interleaved with the set of multiple data tones.

Another method for wireless communication by a wireless communication device is described. The method may include communicating information indicative of an ON state of an IM mode for a PPDU, the PPDU including a preamble portion and a data portion and receiving the PPDU, one or more fields of the preamble portion being communicated via a set of multiple tones according to a first per-tone transmit power, and the data portion being communicated according to a RU that includes a set of multiple pilot tones for IM corresponding to the IM mode, the set of multiple pilot tones corresponding to a null-tone value, and a set of multiple data tones interleaved with the set of multiple pilot tones within the RU, the data portion being communicated via the set of multiple data tones according to a second per-tone transmit power, the second per-tone transmit power being greater than the first per-tone transmit power in accordance with the set of multiple pilot tones corresponding to the null-tone value.

Another wireless communication device for wireless communication is described. The wireless communication device may include a processing system that includes processor circuitry and memory circuitry that stores code. The processing system may be configured to cause the wireless communication device to communicate information indicative of an ON state of an IM mode for a PPDU, the PPDU including a preamble portion and a data portion and receive the PPDU, one or more fields of the preamble portion being communicated via a set of multiple tones according to a first per-tone transmit power, and the data portion being communicated according to a RU that includes a set of multiple pilot tones for IM corresponding to the IM mode, the set of multiple pilot tones corresponding to a null-tone value, and a set of multiple data tones interleaved with the set of multiple pilot tones within the RU, the data portion being communicated via the set of multiple data tones according to a second per-tone transmit power, the second per-tone transmit power being greater than the first per-tone transmit power in accordance with the set of multiple pilot tones corresponding to the null-tone value.

Another wireless communication device for wireless communication is described. The wireless communication device may include means for communicating information indicative of an ON state of an IM mode for a PPDU, the PPDU including a preamble portion and a data portion and means for receiving the PPDU, one or more fields of the preamble portion being communicated via a set of multiple tones according to a first per-tone transmit power, and the data portion being communicated according to a RU that includes a set of multiple pilot tones for IM corresponding to the IM mode, the set of multiple pilot tones corresponding to a null-tone value, and a set of multiple data tones interleaved with the set of multiple pilot tones within the RU, the data portion being communicated via the set of multiple data tones according to a second per-tone transmit power, the second per-tone transmit power being greater than the first per-tone transmit power in accordance with the set of multiple pilot tones corresponding to the null-tone value.

Another non-transitory computer-readable medium storing code for wireless communication is described. The code may include instructions executable by one or more processors to communicate information indicative of an ON state of an IM mode for a PPDU, the PPDU including a preamble portion and a data portion and receive the PPDU, one or more fields of the preamble portion being communicated via a set of multiple tones according to a first per-tone transmit power, and the data portion being communicated according to a RU that includes a set of multiple pilot tones for IM corresponding to the IM mode, the set of multiple pilot tones corresponding to a null-tone value, and a set of multiple data tones interleaved with the set of multiple pilot tones within the RU, the data portion being communicated via the set of multiple data tones according to a second per-tone transmit power, the second per-tone transmit power being greater than the first per-tone transmit power in accordance with the set of multiple pilot tones corresponding to the null-tone value.

In some examples of the method, wireless communication devices, and non-transitory computer-readable medium described herein, the one or more fields of the preamble portion communicated according to the first per-tone transmit power include a LTF.

In some examples of the method, wireless communication devices, and non-transitory computer-readable medium described herein, to receive the data portion of the PPDU, one or more per-tone channel estimations obtained using the LTF may be scaled according to a scaling factor in accordance with the LTF being communicated according to the first per-tone transmit power and the second per-tone transmit power may be scaled relative to the first per-tone transmit power by the scaling factor.

Another method for wireless communication by a wireless communication device is described. The method may include transmitting first information indicative of a threshold quantity of spatial streams for communications of PPDUs in which an IM mode is set to an ON state, communicating second information indicative of the ON state of the IM mode for a PPDU, and receiving the PPDU via a quantity of spatial streams that is less than or equal to the threshold quantity of spatial streams, the PPDU including a data portion that is communicated according to a RU that includes: a set of multiple pilot tones for IM corresponding to the IM mode, and a set of multiple data tones interleaved with the set of multiple pilot tones within the RU.

Another wireless communication device for wireless communication is described. The wireless communication device may include a processing system that includes processor circuitry and memory circuitry that stores code. The processing system may be configured to cause the wireless communication device to transmit first information indicative of a threshold quantity of spatial streams for communications of PPDUs in which an IM mode is set to an ON state, communicate second information indicative of the ON state of the IM mode for a PPDU, and receive the PPDU via a quantity of spatial streams that is less than or equal to the threshold quantity of spatial streams, the PPDU including a data portion that is communicated according to a RU that includes: a set of multiple pilot tones for IM corresponding to the IM mode, and a set of multiple data tones interleaved with the set of multiple pilot tones within the RU.

Another wireless communication device for wireless communication is described. The wireless communication device may include means for transmitting first information indicative of a threshold quantity of spatial streams for communications of PPDUs in which an IM mode is set to an ON state, means for communicating second information indicative of the ON state of the IM mode for a PPDU, and means for receiving the PPDU via a quantity of spatial streams that is less than or equal to the threshold quantity of spatial streams, the PPDU including a data portion that is communicated according to a RU that includes: a set of multiple pilot tones for IM corresponding to the IM mode, and a set of multiple data tones interleaved with the set of multiple pilot tones within the RU.

Another non-transitory computer-readable medium storing code for wireless communication is described. The code may include instructions executable by one or more processors to transmit first information indicative of a threshold quantity of spatial streams for communications of PPDUs in which an IM mode is set to an ON state, communicate second information indicative of the ON state of the IM mode for a PPDU, and receive the PPDU via a quantity of spatial streams that is less than or equal to the threshold quantity of spatial streams, the PPDU including a data portion that is communicated according to a RU that includes: a set of multiple pilot tones for IM corresponding to the IM mode, and a set of multiple data tones interleaved with the set of multiple pilot tones within the RU.

In some examples of the method, wireless communication devices, and non-transitory computer-readable medium described herein, the first information may be received via an ultra-high reliability physical capabilities information element of a management frame.

Another method for wireless communication by a wireless communication device is described. The method may include communicating information indicative of an ON state of an IM mode for a PPDU, transmitting a preamble portion of the PPDU, the preamble portion of the PPDU indicative of PE being applied to a data portion of the PPDU, the data portion of the PPDU including a set of data bits followed by a set of padding bits in accordance with the PE, and transmitting the data portion of the PPDU via a set of symbols that is in accordance with the PE, the set of data bits being transmitted via a first subset of the set of symbols and the set of padding bits being transmitted via a second subset of the set of symbols, a quantity of the second subset of the set of symbols being in accordance with a PE duration and a quantity of padding symbols utilized for the PE and the IM mode.

Another wireless communication device for wireless communication is described. The wireless communication device may include a processing system that includes processor circuitry and memory circuitry that stores code. The processing system may be configured to cause the wireless communication device to communicate information indicative of an ON state of an IM mode for a PPDU, transmit a preamble portion of the PPDU, the preamble portion of the PPDU indicative of PE being applied to a data portion of the PPDU, the data portion of the PPDU including a set of data bits followed by a set of padding bits in accordance with the PE, and transmit the data portion of the PPDU via a set of symbols that is in accordance with the PE, the set of data bits being transmitted via a first subset of the set of symbols and the set of padding bits being transmitted via a second subset of the set of symbols, a quantity of the second subset of the set of symbols being in accordance with a PE duration and a quantity of padding symbols utilized for the PE and the IM mode.

Another wireless communication device for wireless communication is described. The wireless communication device may include means for communicating information indicative of an ON state of an IM mode for a PPDU, means for transmitting a preamble portion of the PPDU, the preamble portion of the PPDU indicative of PE being applied to a data portion of the PPDU, the data portion of the PPDU including a set of data bits followed by a set of padding bits in accordance with the PE, and means for transmitting the data portion of the PPDU via a set of symbols that is in accordance with the PE, the set of data bits being transmitted via a first subset of the set of symbols and the set of padding bits being transmitted via a second subset of the set of symbols, a quantity of the second subset of the set of symbols being in accordance with a PE duration and a quantity of padding symbols utilized for the PE and the IM mode.

Another non-transitory computer-readable medium storing code for wireless communication is described. The code may include instructions executable by one or more processors to communicate information indicative of an ON state of an IM mode for a PPDU, transmit a preamble portion of the PPDU, the preamble portion of the PPDU indicative of PE being applied to a data portion of the PPDU, the data portion of the PPDU including a set of data bits followed by a set of padding bits in accordance with the PE, and transmit the data portion of the PPDU via a set of symbols that is in accordance with the PE, the set of data bits being transmitted via a first subset of the set of symbols and the set of padding bits being transmitted via a second subset of the set of symbols, a quantity of the second subset of the set of symbols being in accordance with a PE duration and a quantity of padding symbols utilized for the PE and the IM mode.

In some examples of the method, wireless communication devices, and non-transitory computer-readable medium described herein, a quantity of the first subset of the set of symbols may be in accordance with an intermediate quantity of data symbols and the quantity of padding symbols, and the quantity of the second subset of the set of symbols may be in accordance with the PE duration, the quantity of padding symbols, a guard interval length between each symbol of the set of symbols, and a length of a symbol.

Another method for wireless communication by a wireless communication device is described. The method may include communicating first information indicative of an ON state of an IM mode for a PPDU, the PPDU including a preamble portion and a data portion, receiving the preamble portion of the PPDU, the preamble portion indicative of an identifier of a BSS within which the wireless communication device operates, and receiving the data portion of the PPDU according to a RU that includes: a set of multiple data tones, and a set of multiple pilot tones for IM corresponding to the IM mode, the set of multiple pilot tones interleaved with the set of multiple data tones within the RU in accordance with at least the identifier of the BSS and a tone mapping distance that is in accordance with a size of the RU.

Another wireless communication device for wireless communication is described. The wireless communication device may include a processing system that includes processor circuitry and memory circuitry that stores code. The processing system may be configured to cause the wireless communication device to communicate first information indicative of an ON state of an IM mode for a PPDU, the PPDU including a preamble portion and a data portion, receive the preamble portion of the PPDU, the preamble portion indicative of an identifier of a BSS within which the wireless communication device operates, and receive the data portion of the PPDU according to a RU that includes: a set of multiple data tones, and a set of multiple pilot tones for IM corresponding to the IM mode, the set of multiple pilot tones interleaved with the set of multiple data tones within the RU in accordance with at least the identifier of the BSS and a tone mapping distance that is in accordance with a size of the RU.

Another wireless communication device for wireless communication is described. The wireless communication device may include means for communicating first information indicative of an ON state of an IM mode for a PPDU, the PPDU including a preamble portion and a data portion, means for receiving the preamble portion of the PPDU, the preamble portion indicative of an identifier of a BSS within which the wireless communication device operates, and means for receiving the data portion of the PPDU according to a RU that includes: a set of multiple data tones, and a set of multiple pilot tones for IM corresponding to the IM mode, the set of multiple pilot tones interleaved with the set of multiple data tones within the RU in accordance with at least the identifier of the BSS and a tone mapping distance that is in accordance with a size of the RU.

Another non-transitory computer-readable medium storing code for wireless communication is described. The code may include instructions executable by one or more processors to communicate first information indicative of an ON state of an IM mode for a PPDU, the PPDU including a preamble portion and a data portion, receive the preamble portion of the PPDU, the preamble portion indicative of an identifier of a BSS within which the wireless communication device operates, and receive the data portion of the PPDU according to a RU that includes: a set of multiple data tones, and a set of multiple pilot tones for IM corresponding to the IM mode, the set of multiple pilot tones interleaved with the set of multiple data tones within the RU in accordance with at least the identifier of the BSS and a tone mapping distance that is in accordance with a size of the RU.

In some examples of the method, wireless communication devices, and non-transitory computer-readable medium described herein, the set of multiple pilot tones may be interleaved according to the identifier of the BSS, the tone mapping distance, and a length of an input vector of an interleaver at a second wireless communication device, the input vector including the set of multiple pilot tones and the set of multiple data tones.

In some examples of the method, wireless communication devices, and non-transitory computer-readable medium described herein, the set of multiple pilot tones may be interleaved according to a shift value that may be in accordance with the identifier of the BSS modulo the tone mapping distance.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communication between a wireless access point (AP) and one or more wireless stations (STAs).

FIG. 3 shows a hierarchical format of an example PPDU usable for communications between a wireless AP and one or more wireless STAs.

FIG. 4 shows an example of a signaling diagram 400 that supports interference mitigation (IM) signaling techniques for a physical layer (PHY) protocol data unit (PPDU).

FIG. 5 shows an example PPDU usable for communication between a wireless AP and one or more wireless STAs.

FIG. 6 shows an example of a resource diagram that supports IM signaling techniques for a PPDU.

FIGS. 7A and 7B show examples of an interleaver process that supports IM signaling techniques for a PPDU.

FIG. 8 shows an example of a process flow that supports IM signaling techniques for a PPDU.

FIG. 9 shows an example of a process flow that supports IM signaling techniques for a PPDU.

FIG. 10 shows a block diagram of an example wireless communication device that supports IM signaling techniques for a PPDU.

FIGS. 11 through 18 show flowcharts illustrating example processes performable by or at a wireless communication device that supports IM signaling techniques for a PPDU.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, two or more wireless communication devices may support an interference mitigation (IM) mode. An IM mode may enable or facilitate at least one wireless communication device to measure or otherwise ascertain information associated with interference experienced at the wireless communication device. The information (which may be derived or measured from IM pilot tones) may be used by the wireless communication device to apply further receiver processing to mitigate the present interference. An IM mode may apply to a physical layer (PHY) protocol data unit (PPDU), such that a wireless communication device may transmit and/or receive a PPDU in accordance with the IM mode. To facilitate the measurement of the interference as part of the IM mode, a wireless device may receive a data portion of a PPDU according to a resource unit (RU) that includes multiple pilot tones, such as subcarriers, interleaved with multiple data tones. The wireless device may receive the data portion of the PPDU via the data tones and may measure, or otherwise ascertain information corresponding to, interference experienced at the wireless device via the pilot tones. Some networks, however, may lack mechanisms according to which wireless communication devices perform the IM mode. For example, some networks may lack mechanisms for coordinating a per-tone transmit power utilized to communicate the multiple data tones, lack mechanisms for coordinating a quantity of spatial streams utilized for transmission of the PPDU, lack mechanisms for coordinating packet extension (PE) for the data portion of the PPDU, lack mechanisms for placing pilot tone locations within the RU, among other examples. Without such mechanisms, a wireless communication device may be unable to accurately (or successfully) utilize the IM mode for the PPDU, which may result in a failure to successfully perform IM.

Various aspects relate generally to IM signaling techniques for communication of PPDUs between two or more wireless devices. Some aspects more specifically relate to power scaling data tones in response to, such as based on or resulting from, pilot tones having a null-toned value during the IM mode. For example, a wireless device may transmit a data portion of the PPDU according to an RU that includes multiple data tones and multiple pilot tones having the null-tone value. The wireless device may transmit the data portion of the PPDU via the multiple data tones according to a first per-tone transmit power, which may be scaled-up relative to a second per-tone transmit power utilized for communication of one or more fields of a preamble portion of the PPDU by a scaling factor. Stated alternatively, the first per-tone transmit power may be greater than the second per-tone transmit power by the scaling factor. In such examples, the wireless device may transmit a long training field (LTF) of a preamble portion of the PPDU, which may be used at a receiving wireless device to obtain channel estimations, at the second (lower) per-tone transmit power. The receiving wireless device may scale a per-tone channel estimation, obtained from the LTF, according to the scaling factor, which may enable the receiving wireless device to equalize the signal corresponding to the data portion of the PPDU and obtain the PPDU. In some other examples, to ensure a same per-tone transmit power utilized for the data portion of the PPDU and the LTF, the wireless device may transmit the LTF via a first subset of a plurality tones according to the first per-tone transmit power (greater per-tone transmit power) and null, such as blank, a second subset of the plurality tones that correspond to, in frequency, the pilot tones. In some other examples, to ensure a same per-tone transmit power utilized for the data portion of the PPDU and the LTF, the wireless device may transmit the LTF via the plurality of tones according to the first per-tone transmit power.

Particular aspects of the subject matter described in this disclosure can be implemented to realize one or more of the following potential advantages. In some examples, by utilizing pilot tones having the null-tone value, the described techniques can be used to increase the per-tone transmit power of the data portion of the PPDU, which may improve a signal-to-noise ratio (SNR) of the transmission of the PPDU, improve reliability of PPDU transmissions, and decrease communication failures. Further, by having the pilot tones correspond to the null-tone value, an average per-symbol transmit power of the symbols used to transmit the data portion of the PPDU may continue to satisfy various spectral mask and/or regulatory threshold, while also achieving a greater per-tone transmit power for the data portion of the PPDU. By transmitting the LTF according to the first (higher) per-tone transmit power, a wireless device that receives the PPDU may not observe a discrepancy between the per-tone transmit power utilized for the data portion of the PPDU and the per-tone channel estimations obtained using the LTF, which may decrease a complexity of demodulating the data portion of the PPDU at the wireless device.

Some other aspects more specifically relate to capability signaling for IM. In some examples, a first wireless device may receive information indicative of a threshold quantity of spatial streams supported, by a second wireless device, for communication of PPDUs in which the IM mode is set to an ON state. The first wireless device may communicate, with the second wireless device, information that indicates the ON state of the IM mode for a PPDU. The first wireless device may transmit the PPDU via a quantity of spatial streams that is less than or equal to the threshold quantity of spatial streams supported by the second wireless device. In such examples, the second wireless device may determine, such as calculate, identify, or obtain, the threshold quantity of spatial streams according to a quantity of receive antennas at the second wireless device, among other factors. To indicate the threshold quantity of spatial streams, the second wireless device may include the threshold quantity of spatial streams in a bit field of an ultra-high reliability (UHR) physical capabilities information element of a management frame. In such examples, the bit field may include two or more bits of data, such that a respective bit value of the two or more bits of data may indicate a respective quantity of spatial streams.

Particular aspects of the subject matter described in this disclosure can be implemented to realize one or more of the following potential advantages. In some examples, by indicating the threshold quantity of spatial streams, the described techniques can be used to ensure the quantity of spatial streams utilized for transmission of the PPDU in which IM mode is set to the ON state is supported by the receiving wireless device, which may improve a reliability of PPDU transmissions and decrease communication failures at the receiving wireless device. Further, by indicating the threshold quantity of spatial streams via the two or more bits of the UHR capabilities information element, the wireless devices may improve coordination for the IM mode, while also reducing communication overhead during capability signaling.

Some other aspects more specifically relate to PEs for PPDUs in which an IM mode is set to an ON state. In some examples, a wireless device may receive a preamble portion of a PPDU in which the IM mode is set to the ON state. The preamble portion of the PPDU may indicate that PE is applied to a data portion of the PPDU and may also indicate one or more parameters corresponding to the PE, such as a guard interval length of the PPDU, a length of the data portion, and/or a padding factor. As part of PE, the wireless device may receive a set of data bits of the data portion of the PPDU via a first subset of a set of symbols and may receive a set of padding bits, corresponding to the PE, via a second subset of the set of symbols. To facilitate such reception, the wireless device may determine a quantity of symbols of the first subset according to an intermediate quantity of data symbols, which may be calculated using the one or more parameters, and according to a quantity of padding symbols. The wireless device also may determine a quantity of symbols of the second subset of symbols according to an intermediate PE duration, which may be calculated using the one or more parameters, the quantity of padding symbols, the guard interval length, and/or a length of a symbol. The quantity of padding symbols may be defined as, or otherwise correspond to, an additional quantity of symbols utilized for data portions of PPDUs in which both the PE mode and the IM mode of operations are applied.

Particular aspects of the subject matter described in this disclosure can be implemented to realize one or more of the following potential advantages. In some examples, by defining and utilizing the quantity of padding symbols for PPDUs in which both the PE mode and the IM mode of operations are applied, the described techniques can be used to increase a PE duration of data portions of PPDUs transmitted according to the IM mode, the wireless devices may fully obtain the data portion (the data of interest) prior to the end of the PPDU, which may increase the likelihood of successfully decoding the data portion of the PPDU. Further, by increasing the PE duration of data portions of PPDUs, the wireless device may utilize the extended PE duration to generate a feedback response, which may improve an accuracy of the feedback response, improve the reliability of the feedback response, and improve coordination between the wireless devices, among other advantages.

Some other aspects more specifically relate to interleaving pilot tones with data tones in a data portion of a PPDU in which the IM mode is set to an ON state. In some examples, the wireless device may communicate, via a trigger frame or a preamble portion of the PPDU, information indicative of the ON state of the IM mode for the PPDU. The wireless device may further indicate, via the preamble portion of the PPDU, an identifier of a basic service set (BSS) within which the wireless device operates. The wireless device may transmit the data portion of the PPDU according to an RU that includes multiple data tones and multiple pilot tones. In such examples, the wireless device, via an interleaver, may interleave the multiple data tones with the multiple pilot tones within the RU according to the identifier of the BSS and a tone mapping distance that is in accordance with a size, such as a quantity of tones, of the RU. In some examples, to interleave the multiple pilot tones with the multiple data tones, the wireless device may shift elements, such as the multiple data tones and the multiple pilot tones, of an input vector to the interleaver by a value that is calculated according to the identifier of the BSS, the tone mapping distance, and a length of the input vector. In some other examples, to interleave the multiple pilot tones with the multiple data tones, the wireless device may shift elements of an output vector of the interleaver by a value that is calculated according to the identifier of the BSS modulo the tone mapping distance.

Particular aspects of the subject matter described in this disclosure can be implemented to realize one or more of the following potential advantages. In some examples, by shifting the pilot tone locations within the RU according to the identifier of the BSS, the tone mapping distance, and/or the size of the input vector, the described techniques can be used to differentiate the pilot tone locations of data portions of PPDUs across different wireless devices, which may enable each wireless device to measure interference experienced at each wireless device and improve the performance of the IM mode at the wireless devices, among other advantages.

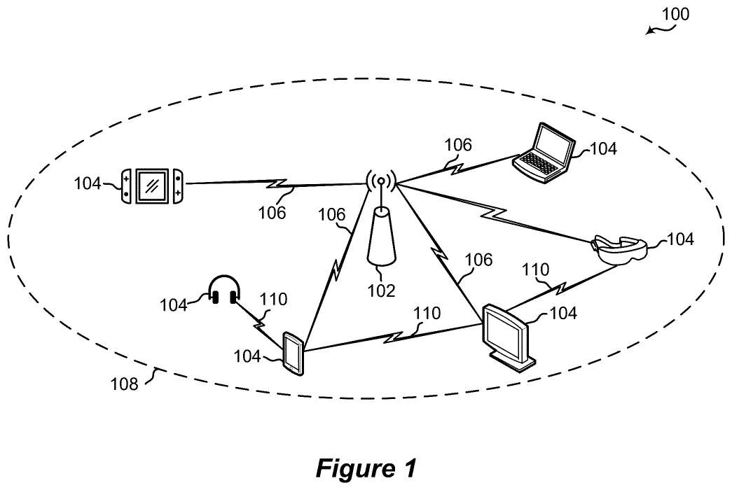

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit.

Each of the STAs 104 also may be referred to as a mobile station (MS), a mobile device, a mobile handset, a wireless handset, an access terminal (AT), a user equipment (UE), a subscriber station, or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure BSS, which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a BSS identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency expectations, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput expectations.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communication (hereinafter also referred to as “Wi-Fi communication” or “wireless packets”) to and from one another in the form of PPDUs.

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communication. For example, the APs 102 or STAs 104, or both, also may be capable of communicating over licensed operating bands, in which multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple subbands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS may involve transmission on the primary 20 MHz channel. As such, in conventional systems, the transmitting device may contend on and win a TXOP on the primary channel to transmit anything at all. However, some APs 102 and STAs 104 supporting ultra-high reliability (UHR) communication or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

In some examples, two or more wireless communication devices (such as two or more APs 102 or two or more STAs 104, or any combination of one or more APs 102 and one or more STAs 104) of the wireless communication network 100 may support receive-side IM (pilots), such as in accordance with an IM mode. An IM mode may be any communication mode, scheme, or procedure according to which a wireless communication device may allocate additional pilot tone subcarriers in one or more OFDM symbols of a data field of a PPDU or otherwise format, generate, or construct a data field of a PPDU to enable or facilitate an interference measurement. For example, one or more wireless communication devices may use IM pilot (which, as used herein, may refer generally to +1/−1 valued or 0 valued) tones for detection and mitigation of interference. Potential sources of interference may include over-the-air (narrowband or wideband) transmissions and/or OBSS transmissions, and/or on-device interference. Such “pilot” tones associated with the IM mode may be pilots embedded per OFDM symbol, null tones, and/or LTF-symbol midambles, among other examples. Such pilot tones may be optionally inserted at a stage in a data field transmitter flow that is separate from carrier frequency offset (CFO) pilots. In other words, within a data field of a PPDU, pilot tones associated with the IM mode (and the IM mode more generally) may be in addition to CFO pilots associated with a CFO measurement.

An “IM mode” may refer generally to any combination of a usage of one or more +1/−1 valued tones, one or more null (0 valued) tones, and/or one or more LTF sequence values distributed throughout at least one data field of a PPDU to enable or otherwise facilitate detection and mitigation of interference. An IM mode design may include interference estimation, receiver processing, and/or usage and signaling aspects. Regarding interference estimation, one or more wireless communication devices may support defined (in accordance with a network specification or one or more signaled indications) locations of pilots (such as within an OFDM time-frequency resource grid), a quantity or density of pilots, values used for pilot tones (including pilot sequence), or additional spreading (in scenarios of MIMO communication), rotation, or scrambling sequences applied to a pilot sequence. One or more parameters associated with the IM mode may indicate locations (such as a pattern) of pilots, a quantity or density of pilots, values used for pilot tones, a spreading sequence applied to an IM pilot sequence, a rotation sequence applied to an IM pilot sequence, and/or a scrambling sequence applied to an IM pilot sequence.

Regarding receiver processing, one or more wireless communication devices may support (in accordance with a network specification or one or more signaled indications) mechanisms for how a receiving device is able to detect a presence and/or a specific location of an interferer, mechanisms for how a receiving device is able to estimate one or more characteristics of the interference, mitigation techniques (such as receive beamforming) for suppressing the interference, or other receiver algorithms associated with the IM mode. Regarding usage and signaling aspects, one or more wireless communication devices may support signaling/indications to indicate whether the IM mode is ON/OFF in transmission, signaling of IM mode operation parameters (such as information indicative of or otherwise associated with a quantity, location, or periodicity, among other example parameters, of pilots or other such IM mechanisms), and/or signaling for a first device to request a second device to enable the IM mode in one or more subsequent packets transmitted by the second device to the first device.

In some networks, such as the wireless communication network 100, the IM mode may be defined (by a network specification) as an optional mode for a set of devices associated with a specific capability or generation. For example, a set of devices (such as all devices) associated with a UHR capability or generation may optionally support the IM mode. In some examples, each device of the set of devices may enable or disable the IM mode on a per-PPDU basis. For example, one or more devices may optionally, selectively, or conditionally support a transmission of PPDUs with IM mode set to an ON state and/or may optionally, selectively, or conditionally support a reception of PPDUs with IM mode set to an ON state. In examples in which a device does not support the IM mode, the device may not expect to receive signaling indicating that the IM mode is enabled (such as in accordance with a rule or expectation defined by a network specification).

In some examples, a wireless communication device or a network may support or define the IM mode for one or more of various transmission or PPDU types. For example, a wireless communication device or a network may support or define the IM mode for one or both of full bandwidth scenarios (such as full bandwidth transmissions) and OFDMA scenarios (such as OFDMA transmissions). Full bandwidth scenarios may include SU PPDUs (both downlink (DL) and uplink (UL)) and non-OFDMA MU-MIMO PPDUs (DL and TB UL). Additionally, puncturing of one or more subbands, as defined in the allowed punctured patterns in a punctured channel information subfield of U-SIG, may be allowed. In some aspects, a PPDU bandwidth subfield and the punctured channel information subfield may jointly indicate an RU or MRU assigned to one user in an SU transmission or a quantity of users in a non-OFDMA MU-MIMO transmission. Additionally, or alternatively, the PPDU bandwidth subfield, the punctured channel information subfield, and an IM mode indication may jointly indicate an RU or MRU assigned to one user in an SU transmission in the IM mode or all users in a non-OFDMA MU-MIMO transmission in the IM mode.

In examples in which an UL or DL PPDU transmission spans a full, an entire, or a complete bandwidth (such as a full operating bandwidth or a full BSS bandwidth), a data field of the UL or DL PPDU may support or otherwise be associated with OFDM pilot tone-based IM mode designs. In some aspects, a wireless communication device may set a state associated with the IM mode to an ON state or an OFF state for all users in a PPDU. In such aspects, and in examples in which the IM mode involves pilots, the pilots may cover a full bandwidth (of the PPDU) and may apply to all users of the PPDU. In some aspects, full bandwidth PPDUs may support one or more of various preamble signal (SIG) field definitions or interpretations to indicate the state associated with the IM mode. Additionally, or alternatively, for a TB UL MIMO PPDU, a trigger frame soliciting the TB UL MIMO PPDU may include (such as carry) IM mode signaling.

In OFDMA scenarios, which may involve both DL and UL scenarios, a bandwidth may be segmented into different RUs and/or MRUs assigned to different users. In such scenarios, and in examples in which the IM mode involves pilots, a wireless communication device or a network may support or define the IM mode such that the IM mode is not defined for DL and UL OFDMA or such that, in DL or UL OFDMA operation, the IM mode design may expect a set of receivers (such as all users) of the PPDU to have IM mode enabled. In other words, in examples in which the IM mode is enabled for a PPDU, the IM mode may apply for a set of receivers (such as all users) of the PPDU. Otherwise, such as if some RUs/MRUs have pilots present while some other RUs/MRUs have no pilots, data field generation and/or parsing may become complicated (in terms of processing costs) and/or the interference management associated with the IM mode may become ineffective. Likewise, IM mode signaling within a preamble of a PPDU may be to the set of receivers (such as all users) of the PPDU, as opposed to being within one or more user information fields of a SIG field (such as one or more user information fields of a UHR-SIG field).

Alternatively, in some implementations, two or more wireless communication devices may support IM mode signaling designs in the context of OFDMA scenarios (such as OFDMA transmissions and/or OFDMA communication schemes). In such implementations, a wireless communication device may transmit a message (such as an MU PPDU or a trigger frame) to multiple other wireless communication devices and may indicate, via one or more fields of the message, information indicative of a respective state associated with the IM mode for each wireless communication device of the multiple other wireless communication devices. For example, the wireless communication device may indicate, via the one or more fields of the message, a first state associated with the IM mode for a first wireless communication device of the multiple other wireless communication devices and a second state associated with the IM mode for a second wireless communication device of the multiple other wireless communication devices. The first state may be the same as or different than the second state, with, for example, each (explicitly or implicitly) separately indicated.

A wireless communication device that receives a PPDU for which the IM mode is set to an ON state may support, implement, or employ one or more mechanisms associated with interference detection and/or estimation (using one or more aspects or components of the IM mode or prior to enabling the IM mode). For example, a wireless communication device may support one or more mechanisms to detect whether interference is present (to determine whether to turn the IM mode to an ON state) and may support one or more mechanisms (once the IM mode is set to the ON state) to estimate one or more characteristics of the interference (for use in receive IM processing). The wireless communication device may detect whether interference is present using a guard interval (GI)-based detection within a data portion of a PPDU and/or using a covariance-based detection within a short interframe space (SIFS) period, among other examples. The wireless communication device may estimate one or more characteristics of the interference (once IM mode is set to the ON state) by measuring pilot tones across time and frequency in accordance with an OFDM tone plan and/or by measuring periodic midambles OFDM symbols, among other examples. Example pilot tone patterns associated with the IM mode are illustrated and described herein.

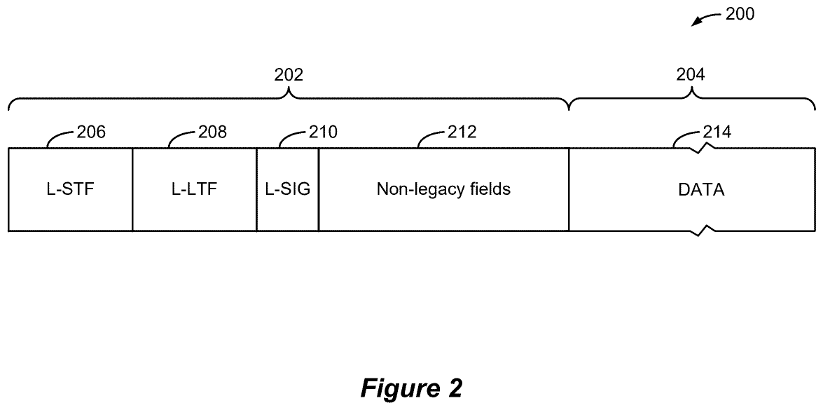

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (such as obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field 214 (illustrated as “DATA” in the example of FIG. 2) that, in turn, may carry higher layer data, for example, in the form of MAC protocol data units (MPDUs) or an aggregated MPDU (A-MPDU).

In some examples, UHR-capable STAs 104 and APs 102 may support unequal modulation techniques (also referred to as unequal quadrature amplitude modulation (QAM)) with joint encoding across multiple streams for MIMO communication. For example, while different data streams may be transmitted using different spatial streams, or different RUs, or both, different spatial streams or RUs may be associated with different levels of quality (such as a different signal to noise ratios (SNRs)), and it may be advantageous to use different (unequal) modulation and coding schemes (MCSs) for different spatial streams or RUs.

To support unequal modulation, an AP 102 may transmit signaling that indicates unequal MCSs across spatial streams or RUs to multiple STAs 104. For example, the AP 102 may transmit an MCS configuration message, which may be an example of a PHY preamble included in control signaling for PHY layer configuration, to indicate the unequal MCSs. In some examples, an MCS field of the MCS configuration message may include entries for unequal QAM schemes across multiple spatial streams. The multiple spatial streams may be encoded with the same code rate.

To support increased range or rate-over-range, a STA 104 and an AP 102 may support extended long range (ELR) PPDU formats. The use of an ELR PPDU format can enable the achievement of a target data rate while maintaining an existing coverage range, reduce an uplink/downlink power imbalance (due to, for example, one or more regulations or hardware differences at the uplink and downlink devices), or extend a coverage range while maintaining a similar, or slightly lower, data rate as compared with other PPDU formats. In some examples, an ELR PPDU may be transmitted over a narrow bandwidth, which may have a lower noise floor and thus higher SNR, which may extend the coverage range. The reliability of the transmission of an ELR PPDU also may be increased as a result of using various optimized coding rates, coded bit repetition schemes, or duplication schemes, which may provide for improved decodability and fewer retransmissions.

In some wireless communication systems, wireless communication devices may support low density parity check (LDPC) coding for forward error correcting purposes to increase the likelihood of accurate data transmission. In some examples, UHR-capable STAs 104 and APs 102 may be capable of selecting among multiple LDPC codeword lengths, including 648 bits, 1296 bits and 1944 bits (defined in legacy IEEE 802.11 wireless communication protocol standards), as well as even longer (extended) codeword lengths, which may increase as operating bandwidths increase, higher modulation orders are introduced, or more spatial streams are available. Using longer LDPC codewords may achieve lower block error rates in some channels, such as channels associated with additive white Gaussian noise. Longer LDPC codewords also may enable more reliable communication in channels with lower SNRs. To facilitate the use of multiple LDPC codeword lengths, a STA 104 and an AP 102 may each include multiple LDPC encoders and multiple LDPC decoders. In some examples, such a STA 104 or AP 102 may connect, aggregate or otherwise utilize multiple encoders to implement a larger single encoder capable of encoding a longer codeword, or similarly, utilize multiple decoders to implement a larger single decoder capable of decoding a longer codeword, which may increase performance gains associated with larger block sizes without substantially increasing the hardware cost or complexity. In some examples, to generate an extended LDPC codeword, a STA 104 or an AP 102 may implement one or more lifting operations to extend a shorter codeword, with each lifting operation extending the previously lifted codeword. A “lifting” operation enables LDPC codes to be implemented using parallel encoding or decoding implementations while also reducing the complexity typically associated with large LDPC codewords. In some examples, a STA 104 or an AP 102 may use mixed codeword lengths for a given transmission. For example, the STA 104 or the AP 102 may encode input bits into one or more codewords having a first, longer codeword length (more than 1944 bits) and one or more codewords having a second, shorter codeword length (1944 bits or less). In such examples, the STA 104 or the AP 102 may perform shortening or puncturing on the codewords having the longer codeword length, or on the codewords having the shorter codeword length, or both.

In accordance with some of the example implementations disclosed herein, a first wireless communication device may transmit the PDU 200 (as a PPDU) to a second wireless communication device and may indicate a state associated with an IM mode for the PDU 200 or another PDU. Additionally, or alternatively, a wireless communication device may transmit the PDU 200 to multiple wireless communication devices and may indicate a respective state associated with an IM mode for each wireless communication device of the multiple wireless communication devices addressed or allocated by the PDU 200. The IM mode may involve pilot tones, such as OFDM tone pilots, among other examples. In some examples in which the IM mode associated with the PDU 200 involves OFDM tone pilots (which may be positioned or located within the data field 214), the first wireless communication device may use the OFDM tone pilots with LDPC coding. For example, a pilot placement design may be related to an LDPC tone mapping distance (DTM) procedure. In such examples, a wireless communication device may refrain from using IM pilots if any user in a PPDU is using a binary convolutional code (BCC) coding scheme. In some other examples in which the IM mode associated with the PDU 200 involves OFDM tone pilots (which may be positioned or located within the data field 214), the first wireless communication device may use the OFDM tone pilots with BCC coding.

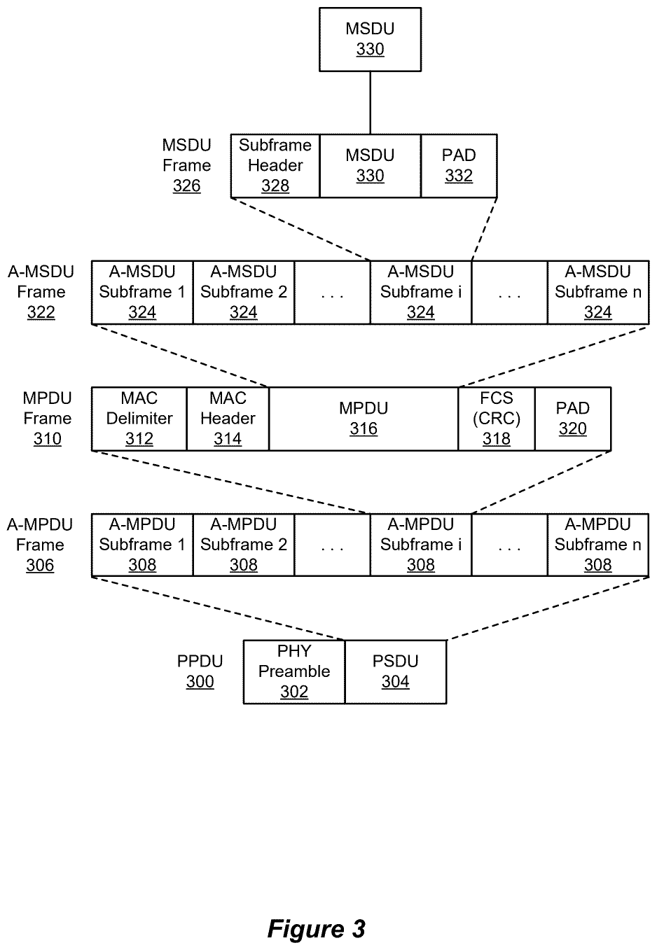

FIG. 3 shows a hierarchical format of an example PPDU usable for communication between a wireless AP and one or more wireless STAs. For example, the AP and STAs may be examples of the AP 102 and the STAs 104 described with reference to FIG. 1. As described, each PPDU 300 includes a PHY preamble 302 and a PSDU 304. Each PSDU 304 may represent (or “carry”) one or more MAC protocol data units (MPDUs) 316. For example, each PSDU 304 may carry an aggregated MPDU (A-MPDU) 306 that includes an aggregation of multiple A-MPDU subframes 308. Each A-MPDU subframe 308 may include an MPDU frame 310 that includes a MAC delimiter 312 and a MAC header 314 prior to the accompanying MPDU 316, which includes the data portion (“payload” or “frame body”) of the MPDU frame 310. Each MPDU frame 310 also may include a frame check sequence (FCS) field 318 for error detection (such as the FCS field 318 may include a cyclic redundancy check (CRC)) and padding bits 320. The MPDU 316 may carry one or more MAC service data units (MSDUs) 330. For example, the MPDU 316 may carry an aggregated MSDU (A-MSDU) 322 including multiple A-MSDU subframes 324. Each A-MSDU subframe 324 may be associated with an MSDU frame 326 and may contain a corresponding MSDU 330 preceded by a subframe header 328 and, in some examples, followed by padding bits 332.

Referring back to the MPDU frame 310, the MAC delimiter 312 may serve as a marker of the start of the associated MPDU 316 and indicate the length of the associated MPDU 316. The MAC header 314 may include multiple fields containing information that defines or indicates characteristics or attributes of data encapsulated within the frame body. The MAC header 314 includes a duration field indicating a duration extending from the end of the PPDU until at least the end of an acknowledgement (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 314 also includes one or more fields indicating addresses for the data encapsulated within the frame body. For example, the MAC header 314 may include a combination of a source address, a transmitter address, a receiver address or a destination address. The MAC header 314 may further include a frame control field containing control information. The frame control field may specify a frame type, for example, a data frame, a control frame, or a management frame.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

In some implementations, the AP 102 and STAs 104 can support various multi-user communication; that is, concurrent transmissions from one device to each of multiple devices (such as multiple simultaneous downlink communication from an AP 102 to corresponding STAs 104), or concurrent transmissions from multiple devices to a single device (such as multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple RUs each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (such as APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communication networks or services. For example, an AI/ML model may be utilized for supporting or improving aspects such as reducing signaling overhead (such as by CSI feedback compression), enhancing roaming or other mobility operations, multi-AP coordination, and generally facilitating network management or optimizing network connections or characteristics to, for example, increase throughput or capacity, reduce latency or otherwise enhance user experience.

In accordance with some of the example implementations disclosed herein, a first wireless communication device may transmit the PPDU 300 to a second wireless communication device and may indicate a state associated with an IM mode for the PPDU 300 and/or another PPDU. In some examples, the first wireless communication device may include information indicative of the state associated with the IM mode for the PPDU 300, or for the other PPDU, within the PHY preamble 302 of the PPDU 300. For example, the PHY preamble 302 may include one or more fields or one or more bits that the first wireless communication device may use to provide an indication of the state associated with an IM mode for the PPDU 300 and/or the other PPDU. Additionally, or alternatively, the PHY preamble 302 may include one or more fields or one or more bits that a wireless communication device may use to provide an indication of a respective state associated with an IM mode for each wireless communication device of multiple wireless communication devices addressed or allocated by the PPDU 300.

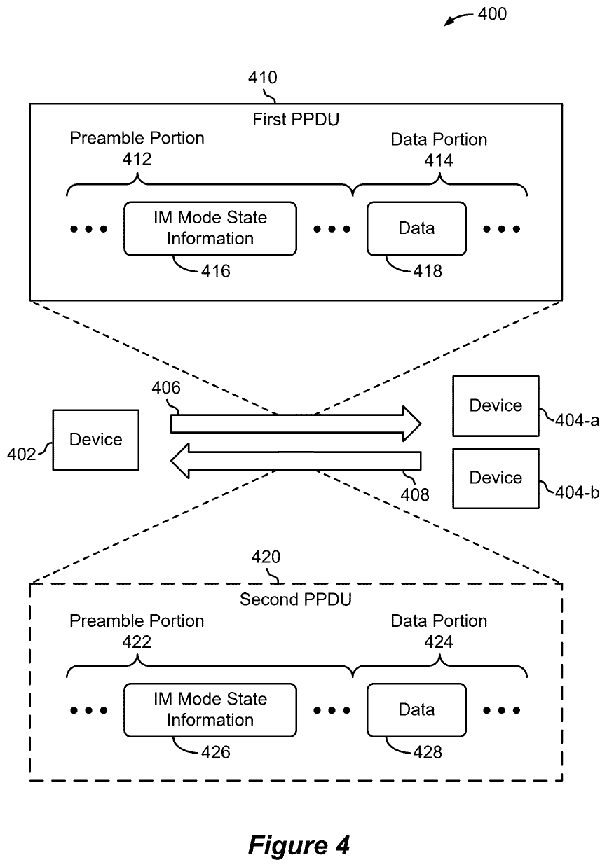

FIG. 4 shows an example signaling diagram 400 that supports IM signaling techniques for a PPDU. The signaling diagram 400 may implement or be implemented to realize one or more aspects of the wireless communication network 100, the PDU 200, or the PPDU 300. For example, the signaling diagram 400 illustrates communication between a wireless communication device 402, a wireless communication device 404-a, and a wireless communication device 404-b. The wireless communication device 402 may be an example of a STA 104 or an AP 102, such as a STA 104 or an AP 102 as illustrated by and described with reference to FIG. 1. The wireless communication device 404-a and the wireless communication device 404-b may each be an example of a STA 104 or an AP 102, such as a STA 104 or an AP 102 as illustrated by and described with reference to FIG. 1.

The wireless communication device 402 and the wireless communication device 404-a and/or the wireless communication device 404-b may communicate with each other via a communication link 406 (which may be one of an UL or a DL, among other examples) and a communication link 408 (which may be the other of the UL or the DL, among other examples). In some examples, the wireless communication device 402 may transmit a first PPDU 410 to the wireless communication device 404-a and/or the wireless communication device 404-b. The first PPDU 410 may include a preamble portion 412 and a data portion 414. The first PPDU 410 may be an example of an MU PPDU, such as a UHR-MU PPDU. A UHR-MU PPDU may be used for DL SU transmissions, UL SU transmissions, OFDMA transmissions, or downlink (full bandwidth) MU-MIMO transmissions. In DL, the UHR-MU PPDU may be associated with a UHR-MU PPDU sub-type, such as a DL SU or a null data packet (NDP) sub-type (which may exclude an RU allocation field or table within a UHR-SIG field), a DL OFDMA sub-type (which may include an RU allocation field or table within a UHR-SIG field), or a DL MU-MIMO sub-type (which may not include an RU allocation field or table within a UHR-SIG field, as DL MU-MIMO transmissions may be full bandwidth).

In some aspects, various (such as all) PPDU sub-types may carry or include one or more user information fields. A user information field may be associated with one of two different types (with both types defined to be 23 bits in some networks, such as UHR networks). A first type of user information field may be a non-MU-MIMO user information field, which a device may use in examples in which a user associated with the user information field is not part of an MU-MIMO grouping (within an RU/MRU or within a full bandwidth PPDU). A second type of user information field may be an MU-MIMO user information field, which a device may use in examples in which a user associated with the user information field is part of an MU-MIMO grouping.

In some implementations, the wireless communication device 402 may transmit the first PPDU 410 (such as a UHR-MU PPDU) with the IM mode set to a specific state (such as an ON state or an OFF state) for a data field 418 within the data portion 414 of the first PPDU 410. In such implementations, the wireless communication device 402 may signal the state associated with the IM mode via the preamble portion 412 of the first PPDU 410. In other words, the wireless communication device 402 may include, within the preamble portion 412 of the first PPDU 410, information 416 indicative of the state associated with the IM mode for the first PPDU 410. The wireless communication device 404-a and/or the wireless communication device 404-b (one or more devices receiving the first PPDU 410) may receive the information 416 and identify, determine, or otherwise ascertain whether, for example, pilot tones associated with the IM mode are present within the data field 418 of the first PPDU 410. The wireless communication device 404-a and/or the wireless communication device 404-b may adjust (such as set, configure, tune, or update) a receive processing in accordance with the indicated state associated with the IM mode. For example, the wireless communication device 404-a and/or the wireless communication device 404-b may use a first receive processing scheme or procedure to receive (and decode, parse, or process) the data field 418 in examples in which the state associated with the IM mode is an OFF state and may use a second receive processing scheme or procedure to receive (and decode, parse, or process) the data field 418 in examples in which the state associated with the IM mode is an ON state.

In some implementations, the information 416 may indicate a respective state associated with the IM mode for each of the wireless communication device 404-a and the wireless communication device 404-b. For example, the information 416 may indicate a first state associated with the IM mode for the wireless communication device 404-a and may indicate a second state associated with the IM mode for the wireless communication device 404-b. In such implementations, the wireless communication device 404-a may adjust (such as set, configure, tune, or update) a receive processing in accordance with the indicated first state associated with the IM mode and the wireless communication device 404-b may adjust (such as set, configure, tune, or update) a receive processing in accordance with the indicated second state associated with the IM mode. In accordance with the separately indicated states associated with the IM mode across the wireless communication device 404-a and the wireless communication device 404-b, the wireless communication device 402 may transmit a first portion of the data field 418 (a portion of data within a first RU or MRU allocated to the wireless communication device 404-a) in accordance with the first state associated with the IM mode and may transmit a second portion of the data field 418 (a portion of data within a second RU or MRU allocated to the wireless communication device 404-b) in accordance with the second state associated with the IM mode. In this context in which the data portion 414 of the first PPDU 410 is transmitted in accordance with separately indicated IM mode states associated with each receiver of the first PPDU 410, the separately indicated IM mode states may be the same or different.

In addition to including information 416 indicative of the state associated with the IM mode for the first PPDU 410, or as an alternative to including information 416 indicative of the state associated with the IM mode for the first PPDU 410, the wireless communication device 402 may include information 416 indicative of a state associated with the IM mode for a second PPDU 420. Such information 416 indicative of the state associated with the IM mode for the second PPDU 420 may be an indication of a state that the wireless communication device 402 requests or commands the wireless communication device 404-a and/or the wireless communication device 404-b to use for one or more (subsequent) PPDUs transmitted by the wireless communication device 404-a and/or the wireless communication device 404-b to the wireless communication device 402. In examples in which the first PPDU 410 indicates a requested or commanded state associated with the IM mode for the second PPDU 420, the wireless communication device 404-a and/or the wireless communication device 404-b may transmit the second PPDU 420 in accordance with the requested or commanded state. The wireless communication device 404-a and/or the wireless communication device 404-b may comply with or otherwise use the requested or commanded state immediately after receiving the first PPDU 410 or some duration after receiving the first PPDU 410. Such a duration may be associated with a capability of the wireless communication device 404-a and/or the wireless communication device 404-b or may be associated with a condition experienced by the wireless communication device 404-a and/or the wireless communication device 404-b, among other examples. Alternatively, in some examples, the wireless communication device 404-a and/or the wireless communication device 404-b may ignore the requested or commanded state.

The second PPDU 420, which may be an example of another UHR-MU PPDU, may include a preamble portion 422 and a data portion 424. The wireless communication device 404-a and/or the wireless communication device 404-b may include, within the preamble portion 422 of the second PPDU 420, information 426 indicative of a state associated with the IM mode for the second PPDU 420. The data portion 424 may include a data field 428, which the wireless communication device 404-a and/or the wireless communication device 404-b may transmit in accordance with the state associated with the IM mode indicated by the information 426. In some examples, the state associated with the IM mode that the wireless communication device 404-a and/or the wireless communication device 404-b uses to transmit the data field 428 of the second PPDU 420 may be in accordance with a requested or commanded state indicated by the first PPDU 410. In some other examples, the wireless communication device 404-a and/or the wireless communication device 404-b may autonomously select the state associated with the IM mode that the wireless communication device 404-a and/or the wireless communication device 404-b uses to transmit the data field 428 of the second PPDU 420. The wireless communication device 402 may receive the second PPDU 420, parse the information 426, and parse the data field 428 in accordance with the indicated state associated with the IM mode. For example, the wireless communication device 402 may use a first receive processing scheme or procedure to receive (and decode, parse, or process) the data field 428 in examples in which the state associated with the IM mode is an OFF state and may use a second receive processing scheme or procedure to receive (and decode, parse, or process) the data field 428 in examples in which the state associated with the IM mode is an ON state.

In some UHR-MU PPDU usage scenarios, the wireless communication device 402, the wireless communication device 404-a, and/or the wireless communication device 404-b may include the information 416 and/or the information 426 (each of which may be understood as one or more IM mode signaling bits) within one or more fields of the preamble portion 412 and/or the preamble portion 422, respectively. In other words, one or more fields within the preamble portion 412 may include, carry, or provide the information 416 and one or more fields within the preamble portion 422 may include, carry, or provide the information 426. The wireless communication device 402, the wireless communication device 404-a, and/or the wireless communication device 404-b may generate the first PPDU 410 and/or the second PPDU 420 such that the information 416 and/or the information 426 are/is located within a common signaling portion of the preamble portion 412 and/or the preamble portion 422, respectively. In other words, the information 416 and the information 426 may be located outside of one or more user-specific fields, such as outside of one or more user information fields. Alternatively, in some implementations, (at least a portion of) the information 416 and (at least a portion of) the information 426 may be located within one or more user-specific fields, such as within one or more user information fields.

Such field(s) that may carry the information 416 and the information 426 may include a universal signal (U-SIG) field and/or a UHR signal (UHR-SIG) common field. In some examples, such field(s) may more specifically include a U-SIG version-dependent field or portion within the U-SIG field and/or a U-SIG overflow field within the UHR-SIG common field (which may be equivalently understood as a common field in a UHR-SIG field, or as one or more U-SIG overflow bits within a UHR-SIG common section). Some PPDU sub-types may be associated with different UHR-SIG field formats/definitions (depending on whether a PPDU is associated with an SU/NDP sub-type, a DL OFDMA sub-type, or a DL MU-MIMO sub-type), with each of such PPDU sub-types including one or more U-SIG overflow bits within a UHR-SIG common field. Some UHR PPDU sub-types (such as a DL OFDMA sub-type) may include 17 U-SIG overflow bits within a UHR-SIG common field and some other PPDU sub-types (such as non-OFDMA sub-types, such as an SU sub-type or an MU-MIMO sub-type) may include 16 U-SIG overflow bits within a UHR-SIG common field. Across such different PPDU sub-types, there may be a quantity of reserved (such as Validate and/or Disregard) bits within the version-dependent portion of the U-SIG field and the UHR-SIG common field, which the wireless communication device 402, the wireless communication device 404-a, and/or the wireless communication device 404-b may use/re-purpose/re-assign to carry IM mode information (such as the information 416 and/or the information 426).

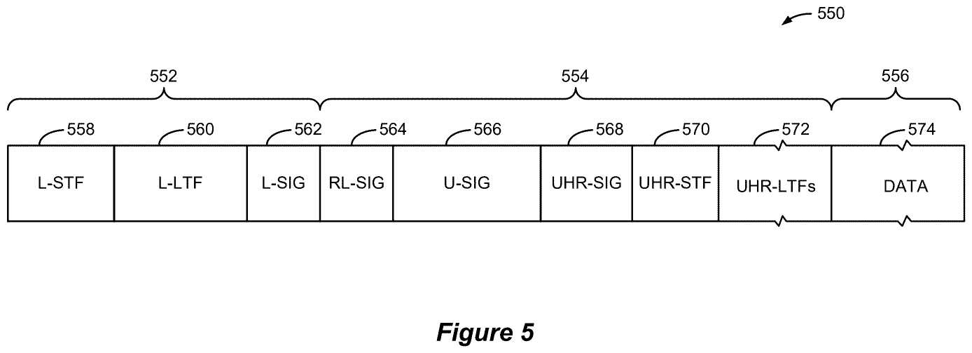

FIG. 5 shows an example PPDU 550 usable for communication between a wireless AP and one or more wireless STAs that supports IM signaling techniques for a PPDU. For example, the AP and STAs may be examples of the AP 102 and the STAs 104 described with reference to FIG. 1. As shown, the PPDU 550 includes a PHY preamble (a preamble portion of the PPDU 550), that includes a legacy portion 552 and a non-legacy portion 554, and a payload 556 (a data portion of the PPDU 550) that includes a data field 574. The legacy portion 552 of the preamble includes an L-STF 558, an L-LTF 560, and an L-SIG 562. The non-legacy portion 554 of the preamble includes a repetition of L-SIG (RL-SIG) 564, a U-SIG field 566 and a UHR-SIG field 568.

The presence of RL-SIG 564 and U-SIG field 566 may indicate to UHR or later version-compliant STAs 104 that the PPDU 550 is a UHR PPDU or a PPDU conforming to any later (post-UHR) version of a new wireless communication protocol conforming to a future IEEE 802.11 wireless communication protocol standard. One or both of the U-SIG field 566 and the UHR-SIG field 568 may be structured as, and carry version-dependent information for, other wireless communication protocol versions associated with amendments to the IEEE family of standards beyond UHR. For example, the U-SIG field 566 may be used by a receiving device (such as an AP 102 or a STA 104) to interpret bits in one or more of the UHR-SIG field 568 or the data field 574. The U-SIG field 566 may include one or more universal, version-independent fields and one or more version-dependent fields. Information in the universal fields may include, for example, a version identifier (starting from the IEEE 802.11be amendment and beyond) and channel occupancy and coexistence information (such as a punctured channel indication).

The version-dependent fields may include format information fields used for interpreting other fields of the U-SIG field 566 and the UHR-SIG field 568 and additional information fields or SU-specific fields that may be useful to intended recipients. In some implementations, the version-dependent fields may include at least a PPDU format field to indicate a general PPDU format for the PPDU 550 (such as a trigger-based (TB), an SU, or an MU PPDU format). Like L-STF 558, L-LTF 560, and L-SIG 562, the information in the U-SIG field 566 and the UHR-SIG field 568 may be duplicated and transmitted in each of the component 20 MHz channels in instances involving the use of a bonded channel.

The non-legacy portion 554 further includes an additional STF (referred to herein as a “UHR-STF 570,” although it may be structured as, and carry version-dependent information for, other wireless communication protocol versions beyond UHR) and one or more additional LTFs (referred to herein as “UHR-LTFs 572,” although they may be structured as, and carry version-dependent information for, other wireless communication protocol versions beyond UHR). The UHR-STF 570 may be used for timing and frequency tracking and AGC, and the UHR-LTF 572 may be used for more refined channel estimation.

The UHR-SIG field 568 may be used by an AP 102 to identify and inform one or multiple STAs 104 that the AP 102 has scheduled UL or DL resources for them. The UHR-SIG field 568 may be decoded by each compatible STA 104 served by the AP 102. The UHR-SIG field 568 also may generally be used by the receiving device to interpret bits in the data field 574. For example, the UHR-SIG field 568 may include RU allocation information, spatial stream configuration information, and per-user (such as STA-specific) signaling information. Each UHR-SIG field 568 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 574.

In accordance with some example implementations of the present disclosure, the U-SIG field 566 and/or the UHR-SIG field 568 may include, carry, or otherwise provide information indicative of a state associated with an IM mode for the PPDU 550 (such as an IM mode for the data field 574 of the PPDU 550) and/or for another PPDU. For example, one or more bits or subfields of the U-SIG field 566 and/or the UHR-SIG field 568 may include, carry, or otherwise provide the information 416 or the information 426 as illustrated by and described with reference to FIG. 4. Such bit(s) or subfield(s) of the U-SIG field 566 and/or the UHR-SIG field 568 may include a version-dependent portion (such as a U-SIG version-dependent field) of the U-SIG field 566 and/or a UHR-SIG common field (such as a common field in the UHR-SIG field 568) one or more U-SIG overflow bis within the UHR-SIG common field) of the UHR-SIG field 568. A wireless communication device that receives the PPDU 550 may interpret the one or more bits or subfields of the U-SIG field 566 and/or the UHR-SIG field 568 to determine or otherwise ascertain the state associated with the IM mode for the PPDU 550 (and/or for another PPDU) and may receive at least the data field 574 of the PPDU 550 in accordance with the state associated with the IM mode (and/or may transmit or receive at least a data field of the other PPDU in accordance with the state associated with the IM mode).

In some implementations, a wireless communication device (such as the wireless communication device 402, the wireless communication device 404-a, or the wireless communication device 404-b) may use (such as re-purpose) a single bit from the version-dependent portion of the U-SIG field 566 and/or from the UHR common field of the UHR-SIG field 568 to indicate whether the payload 556 (the data portion or section) of the PPDU 550 has the IM mode enabled or disabled. In such implementations, a first value of the single bit may indicate that the IM mode is enabled (in an ON state) for the data field 574 of the PPDU 550 and a second value of the single bit may indicate that the IM mode is disabled (in an OFF state) for the data field 574 of the PPDU 550. In some examples, the wireless communication device may select the single bit from a group of unallocated (such as available) Disregard or Validate bits within the version-dependent portion of the U-SIG field 566 and/or from the UHR common field of the UHR-SIG field 568. In some networks, such implementations may be applicable to scenarios in which the PPDU 550 is associated with a DL SU/NDP sub-type, an UL SU/NDP sub-type, a DL OFDMA sub-type, or a DL MU-MIMO sub-type, among other examples.

Additionally, or alternatively, the wireless communication device (such as the wireless communication device 402, the wireless communication device 404-a, or the wireless communication device 404-b) may use (such as re-purpose) two or more bits from the version-dependent portion of the U-SIG field 566 and/or from the UHR common field of the UHR-SIG field 568 to indicate, convey, or create a “UHR Protocols” field, with an encoding of the two or more bits representing (such as indicating) an ON/OFF status for at least one of a set of UHR protocols. Such a set of UHR protocols may include protocols that are unable or not expected to be simultaneously enabled or may include UHR protocols that are able to be simultaneously enabled. For example, the set of protocols may include the IM mode, coordinated beamforming (COBF), frequency domain (FD) unequal modulation (UEQM), or coordinated spatial reuse (CSR), among other examples.

Different codepoints associated with the two or more bits may indicate that a corresponding protocol within the set of protocols is enabled (and may, at least in some examples, implicitly indicate that other protocols of the set are disabled). For example, a first codepoint (such as “00”) may indicate that none of the set of protocols are enabled for the PPDU 550, a second codepoint (such as “01”) may indicate that the IM mode is enabled for the PPDU 550, a third codepoint (such as “10”) may indicate that COBF is enabled for the PPDU 550, and a fourth codepoint (such as “11”) may indicate that FD UEQM is enabled for the PPDU 550. In some examples, the wireless communication device may select the two or more bits from a group of unallocated (such as available) Disregard or Validate bits within the version-dependent portion of the U-SIG field 566 and/or from the UHR common field of the UHR-SIG field 568.

Additionally, or alternatively, the wireless communication device (such as the wireless communication device 402, the wireless communication device 404-a, or the wireless communication device 404-b) may use (such as re-purpose) one or more bits from the version-dependent portion of the U-SIG field 566 and/or from the UHR common field of the UHR-SIG field 568 to indicate one or more parameters (such as one or more operational or operating parameters) associated with the IM mode. Such parameters may depend on a design associated with the IM mode and may include, for example, parameters indicating information associated with a pattern of pilot tones, a quantity of pilot tones, and/or a pilot tone occurrence periodicity, among other examples. In some examples, the wireless communication device may select the one or more bits from a group of unallocated (such as available) Disregard or Validate bits within the version-dependent portion of the U-SIG field 566 and/or from the UHR common field of the UHR-SIG field 568. In some implementations, the wireless communication device may selectively or conditionally use such one or more bits to indicate the one or more parameters associated with the IM mode. For example, the wireless communication device may use the one or more bits to indicate the one or more parameters in examples in which the IM mode is enabled and may refrain from using the one or more bits to indicate the one or more parameters in examples in which the IM mode is disabled. In other words, a wireless communication device receiving the PPDU 550 may disregard a setting of the one or more bits if the IM mode is indicated to be disabled.

Additionally, or alternatively, the wireless communication device (such as the wireless communication device 402, the wireless communication device 404-a, or the wireless communication device 404-b) may use (such as re-purpose) a single bit from the version-dependent portion of the U-SIG field 566 and/or from the UHR common field of the UHR-SIG field 568 to indicate whether a payload (a data portion or section) of another (subsequent) PPDU is requested or commanded to have the IM mode enabled or disabled. In other words, the wireless communication device may use such a single bit to indicate that the wireless communication device is requesting or commanding that the IM mode be enabled or disabled for one or more PPDUs subsequently transmitted by another wireless communication device (one or more wireless communication devices receiving the PPDU 550) in the reverse direction of the link back to the wireless communication device. In such implementations, a first value of the single bit may indicate that the IM mode is requested or commanded to be enabled (in an ON state) for the data field of the subsequent PPDU(s) and a second value of the single bit may indicate that the IM mode is requested or commanded to be disabled (in an OFF state) for the data field of the subsequent PPDU(s). In some examples, the wireless communication device may select the single bit from a group of unallocated (such as available) Disregard or Validate bits within the version-dependent portion of the U-SIG field 566 and/or from the UHR common field of the UHR-SIG field 568. In some examples, one or more bits from the version-dependent portion of the U-SIG field 566 and/or from the UHR common field of the UHR-SIG field 568 may indicate one or more parameters associated with the IM mode requested or commanded to be used for the subsequent PPDU(s).

Additionally, or alternatively, the wireless communication device (such as the wireless communication device 402, the wireless communication device 404-a, or the wireless communication device 404-b) may use (such as re-purpose) one or more bits from the version-dependent portion of the U-SIG field 566 and/or from the common field of the UHR-SIG field 568 to provide an IM mode state indication in OFDMA. For example, the wireless communication device may use a quantity of bits to indicate a specific (such as single) RU or MRU for which a state associated with the IM mode is an ON state. The quantity of bits may be, for example, 9 bits (such as to indicate an RU or MRU from a complete set of RUs or MRUs defined in the 802.11be and 802.11bn specification). Additionally, or alternatively, the quantity of bits (such as the 9 bits) may include or indicate one state that indicates that none of the RUs or MRUs (such as from a complete set of RUs or MRUs defined in the 802.11be and 802.11bn specification) is in an IM mode. Alternatively, if the IM mode is prohibited or not expected for some RUs or MRUs (such as in accordance with a signaled or network specification-based rule, or in accordance with a rule of size of RUs or MRUs that enable the IM mode), the quantity of bits may be less than 9 bits (such as, for example, 6, 7, or 8 bits). In such examples, the quantity of bits may indicate that the IM mode is associated with an ON state for a single RU or MRU, which may implicitly indicate that the IM mode is associated with an OFF state for a remainder of RUs or MRUs allocated by the PPDU 550, or vice versa. Such an indication of a state associated with the IM mode on a per RU or MRU basis may indicate a state associated with the IM mode on a per wireless communication device basis in accordance with each RU or MRU allocated by the PPDU 550 being allocated to one or more wireless communication devices (such that a wireless communication device may expect an IM mode state in accordance with (the same as) an IM mode state indicated for an RU or MRU allocated to the wireless communication device).

Additionally, or alternatively, the wireless communication device (such as the wireless communication device 402, the wireless communication device 404-a, or the wireless communication device 404-b) may use (such as re-purpose) one or more entries of a table associated with one or more RU allocation subfields within the common field of the UHR-SIG field 568 to indicate a state associated with the IM mode. For example, an RU allocation subfield within the common field of the UHR-SIG field 568 may indicate an RU or MRU with the IM mode set to an ON state or an OFF state. In other words, an entry of a table associated with an RU allocation subfield (to which a codepoint of the RU allocation subfield may point) may indicate, for a corresponding RU or MRU, “x user(s) with IM mode set to an ON state.” Additionally, or alternatively, an entry of a table associated with an RU allocation subfield may indicate, for a corresponding RU or MRU, “x user(s) with IM mode set to an OFF state.” In some aspects, x=1.

In such examples, a first RU allocation subfield within the common field of the UHR-SIG field 568 may indicate a first RU or MRU and a first state associated with the first RU or MRU. By way of further example, a second RU allocation subfield within the common field of the UHR-SIG field 568 may indicate a second RU or MRU and a second state associated with the first RU or MRU. In some aspects, such an entry indicative of the IM mode state may be associated with a subset of RUs or MRUs. For example, an RU allocation subfield may indicate an IM mode state for RUs or MRUs associated with at least a threshold size (such as a size of greater than or equal to 242 tones or subcarriers) and may not indicate an IM mode state for RUs or MRUs associated with less than the threshold size (such as less than 242 tones or subcarriers). In examples in which the threshold size is equal to 242 tones or subcarriers, the subset of RUs or MRUs for which an RU allocation subfield may indicate an IM mode state may correspond to RUs or MRUs that may use MU-MIMO or non-MU-MIMO. For example, there may be 8 entries associated with RU996 in the RU allocation subfield to indicate from one to eight users being assigned to an RU996, as in the RU allocation subfield encoding in the 802.11be specification. These 8 entries may be interpreted to indicate from one to eight users being assigned to an RU996 with the IM mode in an OFF state in the RU996. Further, one entry may be added in the RU allocation subfield (by repurposing a reserved entry) to indicate one user being assigned to the RU996 with the IM mode in an ON state in the RU996.

Additionally, or alternatively, a first RU allocation subfield within the common field of the UHR-SIG field 568 may indicate a quantity of RUs or MRUs within a 20 MHz subband and may indicate each of the quantity of RUs or MRUs (such as with size smaller than 242 tones or subcarriers). In some aspects, such an entry indicative of the IM mode state may be associated with all RUs or MRUs within the quantity of RUs or MRUs within a 20 MHz subband. For example, all RUs or MRUs within one 20 MHz subband may be in a same IM mode state and each RU or MRU is assigned one user (in non-MU-M IMO). For example, there may be one entry in the RU allocation subfield, as in the RU allocation subfield encoding in the 802.11be specification, to indicate one user assigned to a first RU106, one user assigned to a center RU26, and one user assigned to a second RU106 within a 20 MHz subband. This entry may be interpreted to indicate one user assigned to a first RU106 with the IM mode in an OFF state, one user assigned to a center RU26 with the IM mode in an OFF state, and one user assigned to a second RU106 with the IM mode in an OFF state, within a 20 MHz subband. Further, one entry may be added in the RU allocation subfield (by repurposing a reserved entry) to indicate one user assigned to a first RU106 with the IM mode in an ON state, one user assigned to a center RU26 with the IM mode in an ON state, and one user assigned to a second RU106 with the IM mode in an ON state, within a 20 MHz subband.

Additionally, or alternatively, the wireless communication device (such as the wireless communication device 402, the wireless communication device 404-a, or the wireless communication device 404-b) may use (such as re-purpose) one or more bits from the version-dependent portion of the U-SIG field 566 and/or from the common field of the UHR-SIG field 568 to indicate a bitmap associated with a set of subbands. Each bit of the bitmap may be associated with a respective subband of the set of subbands and, in some implementations, each bit of the bitmap may indicate whether the IM mode for a corresponding subband is associated with an ON state or an OFF state. For example, a first bit of the bitmap may correspond to a first subband and a second bit of the bitmap may correspond to a second subband. A value of the first bit may indicate whether the IM mode for the first subband is associated with an ON state or an OFF state, a value of the second bit may indicate whether the IM mode for the second subband is associated with an ON state or an OFF state, and so on.

A size of the bitmap may depend on an operating or PPDU bandwidth and/or a granularity of the indicated subbands. For example, the bitmap may be a 4-bit bitmap to indicate IM mode ON/OFF for each 80 MHz subband within (up to) a 320 MHz PPDU bandwidth. By way of further example, the bitmap may be an 8-bit bitmap to indicate IM mode ON/OFF for each 40 MHz subband within (up to) a 320 MHz PPDU bandwidth. By way of further example, the bitmap may be a 16-bit bitmap to indicate IM mode ON/OFF for each 20 MHz subband within (up to) a 320 MHz PPDU bandwidth. In such examples in which the bitmap indicates a respective state associated with the IM mode for each subband of the set of subbands, an RU or MRU may inherit the state associated with the IM mode of the subband including at least a portion of the RU or MRU. In other words, a set of RUs or MRUs (at least partially) within a subband may have a same state associated with the IM as is indicated for the subband (such that, for example, the IM mode for all RU(s) or MRU(s) within a subband is either associated with an ON state or an OFF state). For instance, a union of one or more subbands for which the IM mode is associated with a same state (an ON state or an OFF state) may include one or more RUs or MRUs. In such examples, the wireless communication device 402 may indicate multiple RUs or MRUs having an IM mode associated with an ON state (via indications on a per subband basis). Therefore, the RU allocation subfields and the bitmap of IM mode indication may jointly indicate the RUs and MRUs in the IM mode in OFDMA.

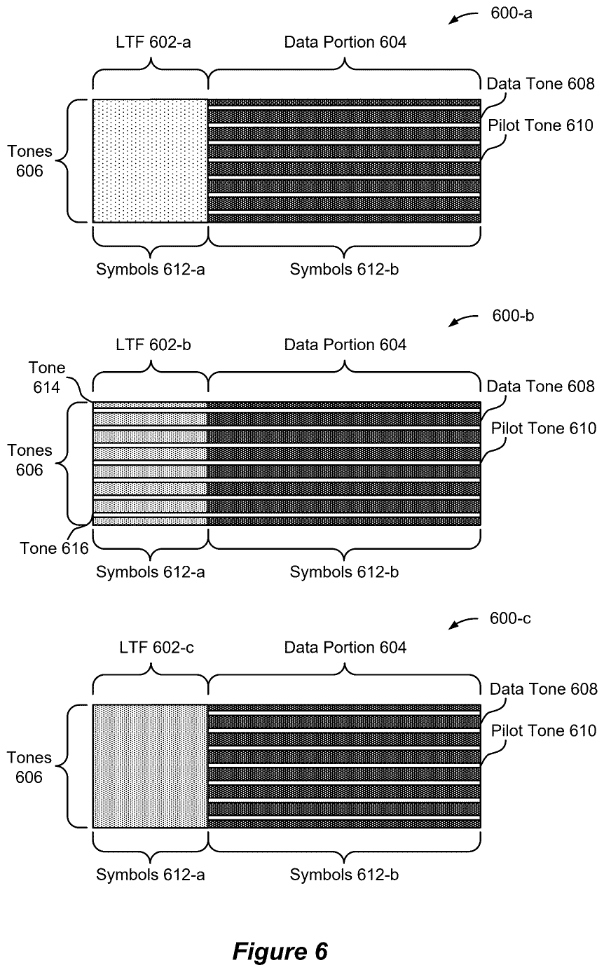

FIG. 6 shows examples of resource diagrams 600, including a resource diagram 600-a, a resource diagram 600-b, and a resource diagram 600-c, that support IM signaling techniques for a PPDU. Aspects of the resource diagrams 600 may implement, or be implemented by, aspects of the wireless communication network 100, the PDU 200, the PPDU 300, the signaling diagram 400, and the PPDU 550, as described with reference to FIGS. 1-5. The resource diagrams 600 may be implemented by a first wireless device (transmitting wireless device) and a second wireless device (a receiving wireless device), which may be examples of APs 102 or STAs 104. The techniques described in the context of the resource diagrams 600 enables the wireless devices to scale up a per-tone transmit power for communication of a data portion 604 of a PPDU relative to one or more fields of a preamble portion of the PPDU.

As described, the first wireless device may transmit a PPDU according to an IM mode. In such cases, the first wireless device may transmit the data portion 604 of the PPDU according to an RU that includes multiple data tones 608 interleaved with multiple pilot tones 610. In some cases, the first wireless device may utilize one or more sequences to transmit the pilot tones 610. In one case, the first wireless device may transmit non-zero-value pilot (NZP) tones (tones having +1/−1 value), as described with reference to FIG. 4. That is, in the case of NZP tones, each pilot tone usable for IM may have a value of +1 or −1, which may be determined according to some overall sequence. In another case, the first wireless device may transmit zero-value pilot (ZP) tones, such as the pilot tones 610, that include a null-tone value (0). Stated alternatively, the first wireless device may not transmit any power on the pilot tones 610.

In some cases, if the ZP pilot tones, such as the pilot tones 610, are utilized for the IM pilot tones, the first wireless device may scale-up the per-tone power of the data tones 608. By doing so, the first wireless device may maintain a same average OFDM symbol power between the symbols 612-a (utilized for the preamble portion of the PPDU) and the symbols 612-b (utilized for the data portion 604). Further, by scaling-up the per-tone power of the data tones 608, the first wireless device may achieve a higher signal power on each data tone 608 (for a given transmit power or power amplifier operating level), which may improve the SNR of each data tone 608.

In such cases, however, by scaling up the per-tone power used to transmit the data portion 604 via the data tones 608, a discrepancy may occur between the per-tone transmit power used to transmit the data portion 604 via the data tones 608 and the per-tone transmit power used to transmit the LTF 602 (UHR-LTF, from which channel estimations at the second wireless device are calculated) via the tones 606. Such a discrepancy may inhibit the second wireless device from correctly equalizing the data portion 604 transmitted via the data tones 608, which may lead to communication failures. That is, because the second wireless device may obtain channel measurements using the LTF 602, which is transmitted at a first per-tone transmit power, the second wireless device may be unable to accurately equalize and obtain the data portion 604 (or the signal carrying the data portion 604) using the channel estimations due to the data portion 604 being transmitted at greater per-tone transmit power than the first per-tone transmit power.

In some implementations, and with reference to the resource diagram 600-a, the first wireless device may transmit the LTF 602-a via the tones 606 according to a first per-tone transmit power that is less than a second per-tone transmit power utilized to transmit the data portion 604 via the data tones 608 in the case that ZP tones are utilized for the pilot tones 610. Stated alternatively, the second per-tone transmit power may be scaled relative to the first per-tone transmit power according to a scaling factor (a per-tone scaling factor or per symbol scaling factor) due to the presence of ZP tones within the RU. In such implementations, the second wireless device may obtain per-tone channel estimations using the LTF 602-a transmitted according to the first per-tone transmit power and proceed to scale up the per-tone channel estimations according to the scaling factor. In this way, the first wireless device may transmit the data portion 604 according to a relatively greater per-tone transmit power, which may improve the SNR of the data portion 604, while also enabling the second wireless device to utilize the per-tone channel estimations obtained using the LTF 602-a, which may decrease complexity at the second wireless device.

For example, in response to (based on or as a result of) using the ZP tones as the pilot tones 610 for IM, the first wireless device may scale-up the per-symbol power of each symbol 612-b to be equal to an average per-symbol power of a symbol 612 that does not include the pilot tones 610, such as the symbols 612-a used to transmit the LTF 602-a. In other words, the first wireless device may scale-up the per-tone transmit power to transmit the data portion 604 relative to the per-tone transmit power used to transmit the LTF 602-a, such that an average per-symbol transmit power of the symbols 612-a is equal to the average per symbol transmit power of the symbols 612-b.

To do so, the first wireless device may determine (calculate, identify, or obtain) an intermediate scaling factor (a total power boost factor) according to a quantity of the tones 606 (allocated RU), a quantity of the pilot tones 610 (usable as IM pilot tones), a quantity of the data tones 608, and/or a quantity of CFO tracking tones (total quantity of tones−IM pilot tones=quantity of data tones+CFO tracking tones). For example, the first wireless device may determine the intermediate scaling factor as the inverse of the quantity of data tones 608 divided by the total quantity of tones (1/(quantity of data tones/total quantity of tones)). Stated alternatively, the intermediate scaling factor may be equal to the quantity of the tones 606 divided by the quantity of the data tones 608.

After determining the intermediate scaling factor, the first wireless device may determine the scaling factor according to the square root of the intermediate scaling factor. After determining the scaling factor, the first wireless device may apply the scaling factor to the per-tone transmit power used to transmit the data portion 604 for each data tone 608 within each symbol 612-b of the symbols 612-b. Stated alternatively, the first wireless device may transmit the data portion 604 according to the second per-tone transmit power that is equal to the first per-tone transmit power multiplied by the scaling factor (the first per-tone transmit power*the scaling factor).

As an illustrative example, if the RU comprises 996 tones (RU996), the first wireless device may determine that the total quantity of pilot tones 610, which correspond to IM pilot tones, is 98. The first wireless device may determine a quantity of data tones 608 as 898 (996−98=898). The first wireless device may determine the intermediate scaling factor as approximately 1.109 (1/(898/996)=~1.109). The first wireless device may determine the scaling factor, that is to be applied for communicating the data portion 604 in each of the 898 tones, as 1.053 (sqrt (1.109)=1.053). The first wireless device may proceed to apply the scaling factor for 1.053 to a per-tone transmit power used to transmit the data portion 604 to obtain the final (second) per-tone transmit power. For example, if X is the per-tone transmit power utilized for the communication of the LTF 602-a, the per-tone transmit power utilized for the data portion 604 may be equal to X*1.053.

At the second wireless device, to handle the discrepancy in the first per-tone transmit power used to transmit the LTF 602-a and the second per-tone transmit power used to transmit the data portion 604, the second wireless device may apply the scaling factor to the per-tone channel estimations prior to using the per-tone channel estimations to demodulated the data portion 604 (prior to equalizing and obtaining the data portion 604). In such examples, the first wireless device may indicate the scaling factor to the second wireless device, for example, via the preamble portion of the PPDU or via a trigger frame scheduling the PPDU. In some other examples, the second wireless device may independently calculate the scaling factor using the same techniques as the first wireless device and determine whether to use the scaling factor during reception and processing of the data portion 604 of the PPDU according to, such as via, an IM ON or OFF state indication in the preamble portion of the PPDU.

In some other implementations, and with reference to the resource diagram 600-b, the first wireless device may transmit the data portion 604 via the data tones 608 according to the second per-tone transmit power, as described with reference to the resource diagram 600-a. To avoid any discrepancies in the transmit power at the second wireless device, the first wireless device may transmit the LTF 602-b via the tones 614 (e.g., first subset) of the tones 606 according to the second per-tone transmit power. In such examples, the second per-tone transmit power may be scaled-up from a per-tone transmit power utilized for one or more other fields of the preamble portion of the PPDU according to the scaling factor, which may be calculated in a similar manner as described with reference to the resource diagram 600-a.

To achieve the same average per-symbol power between the symbols 612-a and the symbols 612-b, the first wireless device may null, or otherwise blank, the tones 616 (e.g., second subset) of the tones 606, such that the tones 616 have a null-value or correspond to same power as ZP tones. In such examples, a location, in frequency, of the tones 616 may correspond to the pilot tones 610. Stated alternatively, the tones 616 may correspond, one for one, with the pilot tones 610 and correspond to the null-tone value. Because the second wireless device may process the data portion 604 without scaling the per-tone channel estimations, complexity at the second wireless device may decrease. In some examples, the first wireless device may indicate, via the preamble portion of the PPDU, the ON or OFF state of the IM mode, which may indicate to the second wireless device that the corresponding pilot tone locations in the LTF 602-b have the null-tone values.

In some implementations, and with reference to the resource diagram 600-c, the first wireless device may transmit the data portion 604 via the data tones 608 according to the second per-tone transmit power, as described with reference to the resource diagram 600-a. To avoid any discrepancies in the transmit power at the second wireless device, the first wireless device may transmit the LTF 602-c via the tones 606 according to the second per-tone transmit power. In such examples, the second per-tone transmit power may be scaled-up from a per-tone transmit power utilized for one or more other fields of the preamble portion of the PPDU according to the scaling factor, which may be calculated in a similar manner as described with reference to the resource diagram 600-a. In such examples, an average per-symbol transmit power of the symbols 612-a may be greater than the average per-symbol transmit power of the symbols 612-b due to the pilot tones 610 corresponding to ZPs. Because the second wireless device may process the data portion 604 without scaling the per-tone channel estimations, complexity at the second wireless device may decrease. In some examples, the first wireless device may indicate, via a preamble portion of the PPDU, the ON or OFF state of the IM mode, which may indicate to the second wireless device that the LTF 602-c is transmitted using the second per-tone power via the tones 606.

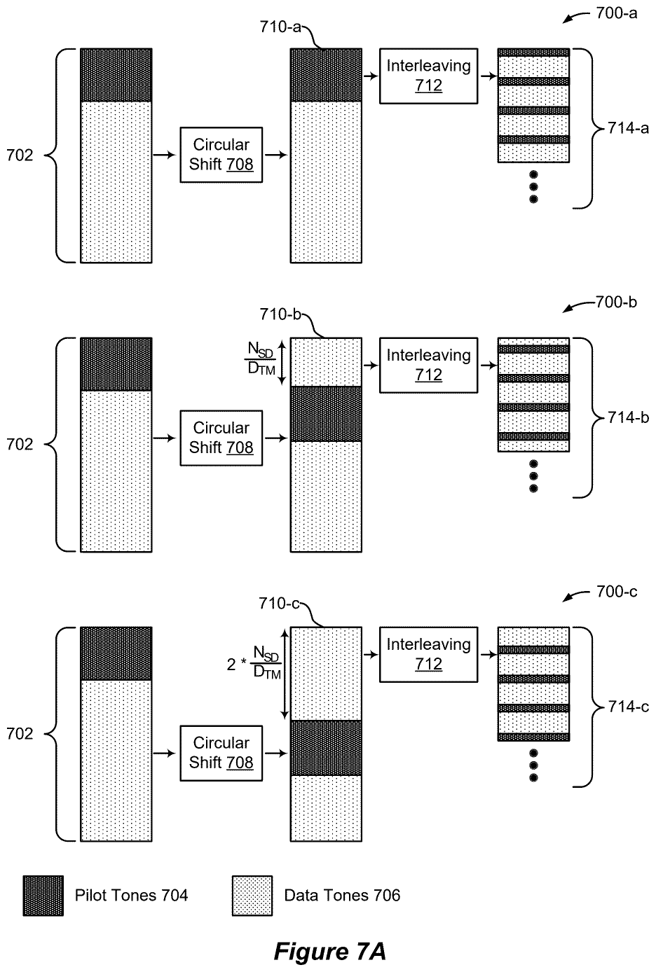

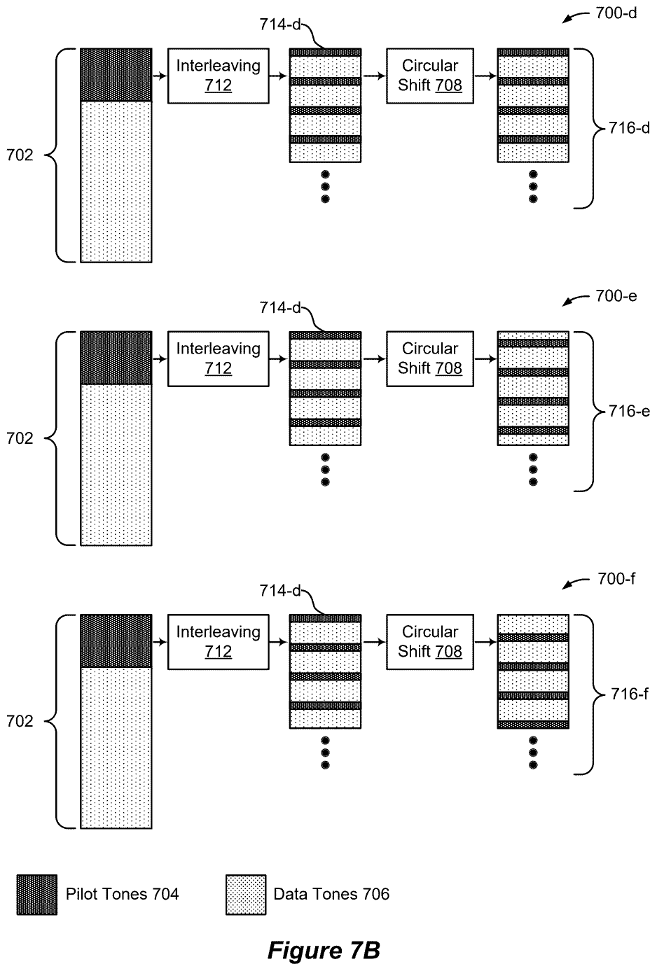

FIGS. 7A and 7B show examples of interleaver processes 700, such as an interleaver process 700-a, an interleaver process 700-b, an interleaver process 700-c, an interleaver process 700-d, an interleaver process 700-e, and an interleaver process 700-f, that support IM signaling techniques for a PPDU. Aspects of the interleaver processes 700 may implement, or be implemented by, aspects of the wireless communication network 100, the PDU 200, the PPDU 300, the signaling diagram 400, and the PPDU 550, as described with reference to FIGS. 1-5. The interleaver processes 700 may be implemented by a first wireless device (a transmitting wireless device), which may be an example of an AP 102 or a STA 104. The techniques described in the context of the interleaver processes 700 enables the first wireless device to interleave the pilot tones 704 with the data tones 706 within an RU according to an identifier of a BSS in which the first wireless device operates.

As described, as part of the IM mode, the first wireless device may transmit a data portion of the PPDU according to a RU that includes multiple pilot tones 704 interleaved with multiple data tones 706. In some cases, if the pilot tones 704 correspond to ZP tones for IM, a second wireless device receiving the data portion of the PPDU may be unable to accurately measure OBSS interference in the case that the OBSS transmissions, which may interfere with the PPDU, also include IM pilot tones. For example, if pilot tone locations of the PPDU and the OBSS transmission (OBSS PPDU) align, the second wireless device may be unable to measure some components of the interference due to the compromise in the orthogonality between the tones of the PPDU and the OBSS transmission, and/or due to the properties of the OFDM and non-synchronized OFDM symbol timing across the two BSSs, among other factors.

To avoid alignment between the pilot tones 704 of a PPDU and OBSS PPDUs, the first wireless device may cyclically shift locations of the pilot tones 704 and the data tones 706 within an RU allocated for the PPDU. In such examples, the first wireless device may shift the pilot tones 704 and the data tones 706 according to (based on or as influenced by) an identifier of the BSS (BSS color) in which the first wireless device operates. For example, each BSS may be assigned an identifier (BSS color) that is a value between 0 and 63, which may allow for differentiation between BSSs in denser or more congested networks. In such examples, wireless devices may communicate the identifier of the BSS via one or more fields of the preamble portion of the PPDU. As such, because the identifier of the BSS may be different than OBSSs in proximity to the BSS, the first wireless device may shift the pilot tones 704 and the data tones 706 according to the identifier of the BSS, which may improve the likelihood that the locations of the pilot tones 704 within an RU are different than the locations of the pilot tones of OBSS PPDUs.

To achieve the cyclic shift, the first wireless device may perform a circular shift 708 on an input vector 702 of an interleaver of the first wireless device. In such examples, each element of the input vector 702 may correspond to (be allocated as) either a pilot tone 704 or a data tone 706. Additionally, because the first wireless device performs interleaving 712 (via an LDPC interleaver) on a per-RU basis (or per RU996 in case of RUs of greater than 80 MHz), each element of the input vector 702 may correspond to (map to or represent) a tone of an allocated RU. The size of the RU may influence (set) a tone mapping distance (D_{TM}) utilized in the interleaving 712 and influence a size of the input vector 702 (N_{SD}) of the interleaver.

In some implementations, for example, with reference to the interleaver processes 700-a, 700-b, and 700-c, the first wireless device may perform the circular shift 708 on the input vector 702. Stated alternatively, the first wireless device may perform the circular shift 708 on the input vector 702 prior to interleaving 712 the pilot tones 704 with the data tones 706. In such implementations, the first wireless device may perform the circular shift 708 according to the identifier of the BSS within which the first wireless device operates, according to the tone mapping distance, and according to the size of the input vector 702. For example, the first wireless device may circularly shift the elements of the input vector 702 by a shift value. In such examples, the shift value may be computed according to the following Equation:

$$( BSSColor \% {D}_{TM} ) ( \frac{{N}_{SD}}{{D}_{TM}} ) .$$

In response to shifting the input vector 702, the first wireless device may obtain an input vector 710 and perform the interleaving 712 using the input vector 710.

As an illustrative example, and with reference to the interleaver process 700-a, if the identifier of the BSS modulo the tone mapping distance is equal to 0 ((BSSColor % D_{TM})=0), then the shift value may be equal to 0. The first wireless device may not shift the elements of the input vector 702, such that an input vector 710-a is equivalent to the input vector 702. The first wireless device may perform the interleaving 712 of the pilot tones 704 and the data tones 706 according to the input vector 710-a and obtain an output vector 714-a.

As another illustrative example, and with reference to the interleaver process 700-b, if the identifier of the BSS modulo the tone mapping distance is equal to 1 ((BSSColor % D_{TM})=1), then the shift value may be equal to

$$( \frac{{N}_{SD}}{{D}_{TM}} ) .$$

The first wireless device may shift the elements of the input vector 702 by the shift value

$$( ( \frac{{N}_{SD}}{{D}_{TM}} ) ) ,$$

such that an input vector 710-b is offset from the input vector 702. The first wireless device may perform the interleaving 712 of the pilot tones 704 and the data tones 706 according to the input vector 710-b and obtain an output vector 714-b. As illustrated, because the input vectors 710-a and 710-b are offset from one another, the pilot tones 704 of the output vectors 714-a and 714-b may also be offset, which may avoid overlapping pilot tone locations.

As another illustrative example, and with reference to the interleaver process 700-c, if the identifier of the BSS modulo the tone mapping distance is equal to 2 ((BSSColor % D_{TM})=2), then the shift value may be equal to

$$2 * ( \frac{{N}_{SD}}{{D}_{TM}} ) .$$

The first wireless device may shift the elements of the input vector 702 by the shift value

$$( \frac{{N}_{SD}}{{D}_{TM}} ) ) ,$$

such that an input vector 710-c is offset from the input vector 702. The first wireless device may perform the interleaving 712 of the pilot tones 704 and the data tones 706 according to the input vector 710-c and obtain an output vector 714-c. As illustrated, because the input vectors 710-a, 710-b, and 710-c are offset from one another, the pilot tones 704 of the output vectors 714-a, 714-b, and 714-c may also be offset, which may avoid overlapping pilot tone locations.

In some other implementations, for example, with reference to the interleaver processes 700-d, 700-e, and 700-f, the first wireless device may perform the circular shift 708 after interleaving 712. Stated alternatively, the first wireless device may perform the circular shift 708 on the output vector 714-d obtained as a result of interleaving 712 the pilot tones 704 with the data tones 706. In such implementations, the first wireless device may perform the circular shift 708 according to the identifier of the BSS within which the first wireless device operations and according to the tone mapping distance. For example, the first wireless device may circularly shift the elements of the output vector 714-d by a shift value. In such examples, the shift value may be computed according to the following Equation: (BSSColor % D_{TM}). In response to shifting the output vector 714-d, the first wireless device may obtain an output vector 716.

As an illustrative example, and with reference to the interleaver process 700-d, if the identifier of the BSS modulo the tone mapping distance is equal to 0 ((BSSColor % D_{TM})=0), then the shift value may be equal to 0. The first wireless device may not shift the elements of the output vector 714-d, such that an output vector 716-d is equivalent to the output vector 714-d.

As another illustrative example, and with reference to the interleaver process 700-e, if the identifier of the BSS modulo the tone mapping distance is equal to 1 ((BSSColor % D_{TM})=1), then the shift value may be equal to 1. The first wireless device may shift the elements of the output vector 714-d by the shift value, such that an output vector 716-e is offset from the output vector 714-d. As illustrated, because different circular shifts 708 are applied to the output vector 714-d, the pilot tones 704 of the output vectors 716-d and 716-e may be offset, which may avoid overlapping pilot tone locations.

As another illustrative example, and with reference to the interleaver process 700-f, if the identifier of the BSS modulo the tone mapping distance is equal to 2 ((BSSColor % D_{TM})=2), then the shift value may be equal to 2. The first wireless device may shift the elements of the output vector 714-d by the shift value, such that an output vector 716-f is offset from the output vector 714-d. As illustrated, because different circular shifts 708 are applied to the output vector 714-d, the pilot tones 704 of the output vectors 716-d, 716-e, and 716-f may be offset, which may avoid overlapping pilot tone locations.

The first wireless device may utilize the interleaver processes 700 to offset the locations of the pilot tones 704 across BSSs of different BSS colors, which may increase the likelihood of overlapping pilot tone locations, improve the IM measurements, among other advantages.

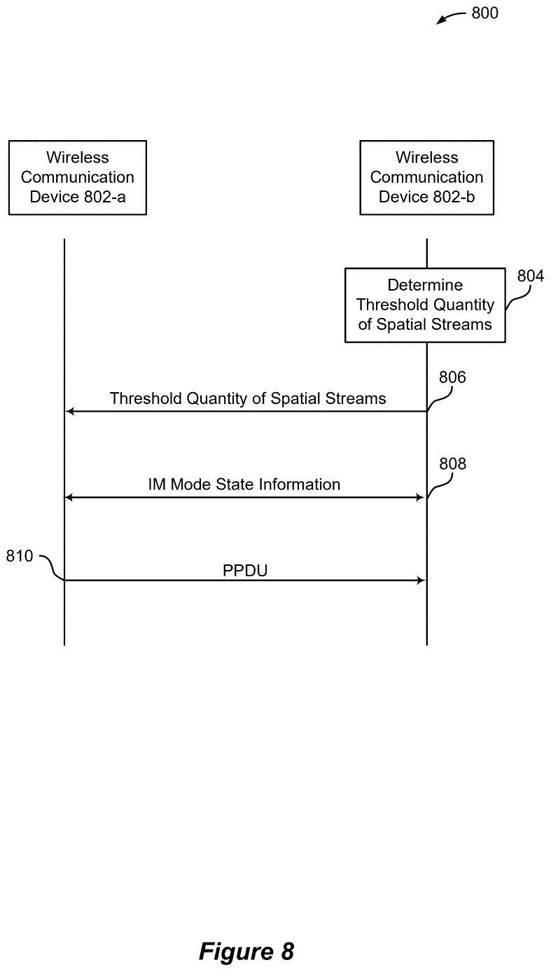

FIG. 8 shows an example of a process flow 800 that supports IM signaling techniques for a PPDU. Aspects of the process flow 800 may implement, or be implemented by, aspects of the wireless communication network 100, the PDU 200, the PPDU 300, the signaling diagram 400, and the PPDU 550, as described with reference to FIGS. 1-5. The process flow 800 may be implemented by a wireless communication device 802-a and a wireless communication device 802-b, which may be examples of APs 102 or STAs 104. The techniques described in the context of the process flow 800 enables the wireless communication devices 802 to negotiate a quantity of spatial streams utilized for communication of a PPDU for which IM mode is set to an ON state.

As described, as part of the IM mode, a wireless communication device 802-a may transmit a data portion of the PPDU according to an RU that includes multiple pilot tones interleaved with multiple data tones. The wireless communication device 802-b (receiving wireless communication device) may utilize the IM tones, the spatial properties of a channel between the wireless communication devices, and/or multiple receiver chains (receiving antennas) at the wireless communication device 802-b to generate filters to suppress unwanted interference from other wireless communication devices. As part of suppressing the interference, the wireless communication device 802-b may leverage the available spatial degrees of freedom (DoF) in the channel. In such cases, however, a quantity of available DoF in the channel may depend on (be based on, calculated on, or restricted according to) the quantity of receive antennas at the wireless communication device 802-b and a quantity of DoF already being used at the wireless communication device 802-b to receive the data portion from the wireless communication device 802-a (from the intended transmitter).

In MIMO transmissions, the quantity of spatial streams (Nss) may generally be determined (selected or otherwise chosen) to be within the quantity of available DoF in the channel between the wireless communication devices 802. That is, the wireless communication devices 802 may determine the quantity of spatial streams according to the quantity of available DoF in the channel. Because IM and MIMO both utilize the spatial DoF available at the wireless communication device 802-b, it may be desirable to enable the wireless communication device 802-b to signal a limit on the quantity of spatial streams utilized by the wireless communication device 802-a to send a PPDU for which IM pilots are present in the data portion of the PPDU transmission.

In some implementations, the wireless communication device 802-b may transmit an indication of a threshold quantity of spatial streams supported by the wireless communication device 802-b, for example, via a bit field of a UHR capability element of a management frame. In this way, the wireless communication device 802-b may determine what value to signal by considering the quantity of receive antennas at the wireless communication device 802-b and other receiver processing capabilities. That is, because an implementation of receiving antennas (receive chains) are different at different wireless communication devices 802, the wireless communication devices 802 may have utilize more or less available DoF to effectively perform interference suppression.

For example, at 804, the wireless communication device 802-b may determine (obtain, identify, or calculate) the threshold quantity of spatial streams supported at the wireless communication device 802-b. In such examples, the wireless communication device 802-b may determine the threshold quantity of spatial streams as a function of a quantity of receive antennas at the wireless communication device 802-b and an expected performance of demodulation and interference mitigation implementations at the wireless communication device 802-b. That is, the wireless communication device 802-b may determine the threshold quantity of spatial streams according to the quantity of receive antennas at the wireless communication device 802-b, a performance metric corresponding to demodulation operations at the wireless communication device 802-b, and/or a performance metric corresponding to IM operations at the wireless communication device 802-b. In some implementations, the wireless communication device 802-b may determine the threshold quantity based on the spatial DoF in the receive channel as seen by the wireless communication device 802-b, which may be based on (dependent on or determined by) the quantity of receive antennas.

As an illustrative example, the wireless communication device 802-b may include 4 receive antennas (4 receive antenna chains) and be capable of receiving up to four spatial streams (Nss=4) of a data portion of a PPDU for which IM is set to the OFF state. In such examples, the four receive antenna channels may have four spatial DoF, from which the wireless communication device 802-b may resolve and/or demodulate up to four spatial streams of the data portion. In actuality, some wireless channel realizations of wireless communication devices 802 may have properties that do not fully support up to the full quantity of DoF for the spatial streams. As such, an upper bound of spatial streams supported by the wireless communication device 802-b may be the four spatial streams. In examples in which the wireless communication devices 802 implement IM, the wireless communication device 802-b may be designed to leverage some of the available DoF in the channel to spatially suppress (for example, through linear algebra and/or signal processing) the interference experienced at the wireless communication device 802-b. In such examples, the wireless communication device 802-b, having four receiving antenna chains, may determine that two DoF are utilized to perform IM according to an implementation of the demodulation and IM operations at the wireless communication device 802-b. The wireless communication device 802-b may determine that the threshold quantity of spatial streams for PPDUs in which the IM mode is set to the ON state is equal to two (Nss=2), such that a quantity of spatial streams plus the quantity of DoFs of the channel (2 Nss+2 DoF) may be equal to a total quantity of DoFs (4) available in channel for IM.

At 806, the wireless communication device 802-b may transmit a management frame that indicates the threshold quantity of spatial streams determined at 804. To indicate the threshold quantity of spatial streams, the wireless communication devices 802 may utilize a bit field within an UHR capability information element of the management frame. In such examples, the UHR capability information element may include other bit fields that correspond to other capabilities of the wireless communication devices 802, such as a bit field indicating whether the wireless communication devices 802 support the IM mode (support the use of pilot tones usable as IM tones).

In such examples, the bit field that indicates the threshold quantity of spatial streams may include two bits, where each bit value of the two bits of data indicates a different quantity of spatial streams. An example of the bit field is illustrated below in Table 1.

TABLE 1
Spatial Stream Bit Field

| Subfield | Description | Encoding |
|---|---|---|
| Rx Nss Max | Indicates the threshold quantity | 2 Bits: |
| with IM Pilots | of spatial streams to be used in | 00 - 1 Spatial Stream |
| Active | transmission sent to the | 01 - 2 Spatial Streams |
| | corresponding device when | 10 - 3 Spatial Streams |
| | IM pilots are on. | 11 - 4 Spatial Streams |

Although illustrated and described as including two bits of data, the bit field may include any quantity of bits (one or more bits), where each bit value of the quantity of bits indicates a different quantity of spatial streams.

At 808, the wireless communication devices 802 may communicate IM mode state information, which may be example of the IM Mode state information described with reference to FIG. 4. In some examples, the wireless communication device 802-a or the wireless communication device 802-b may transmit a trigger frame that schedules a PPDU. The trigger frame may indicate that the IM mode is set to the ON state. In some other examples, the wireless communication device 802-a may transmit the IM mode state information via a preamble portion of the PPDU, as described with reference to FIG. 4.

At 810, the wireless communication device 802-a may transmit the PPDU. In such examples, the wireless communication device 802-a may transmit the preamble portion, the data portion, or both of PPDU via a quantity of spatial streams that is less than or equal to the threshold quantity of spatial streams indicated at 806. That is, the wireless communication device 802-a may limit the quantity of spatial streams used for the PPDU transmission according to the indicated threshold. By transmitting the PPDU via the quantity of spatial streams that are based on the threshold quantity of spatial streams supported by the wireless communication device 802-b, the wireless communication device 802-b may have an increased likelihood of receiving and successfully processing and decoding the PPDU.

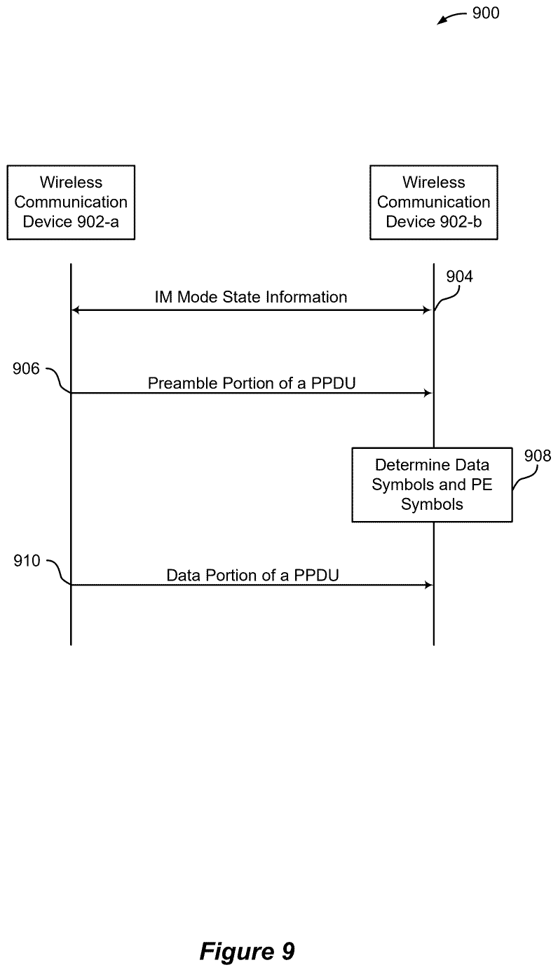

FIG. 9 shows an example of a process flow 900 that supports IM signaling techniques for a PPDU. Aspects of the process flow 900 may implement, or be implemented by, aspects of the wireless communication network 100, the PDU 200, the PPDU 300, the signaling diagram 400, and the PPDU 550, as described with reference to FIGS. 1-5. The process flow 900 may be implemented by a wireless communication device 902-a and a wireless communication device 902-b, which may be examples of APs 102 or STAs 104. The techniques described in the context of the process flow 900 enables the wireless communication devices 902 to extend a PE duration for a data portion of a PPDU for which the IM mode is set to an ON state.

The wireless communication devices 902 may utilize PE of PPDUs to lengthen a data portion, such as the data field 214 or the data field 574, of PPDUs via padding bits, such that a total quantity of symbols (OFDM symbols) used to communicate the data portion of the PPDU is increased. That is, as part of PE, the data portion of the PPDU may include a set of data bits and a set of padding bits, such that a quantity of symbols utilized to transmit the data portion of the PPDU may be increased by the inclusion of the set of padding bits. Doing so may extend a time frame for the wireless communication device 902-b (a receiving wireless communication device) to complete packet reception and processing. For example, in some cases, in response to receiving a PPDU, the wireless communication device 902-b may transmit a feedback message (an ACK/NACK message) within a threshold duration, such as a SIFS, from reception of a final symbol of the PPDU (an end of the PPDU).

By utilizing PE, the wireless communication device 902-b may ensure reception of the set of data bits (actual data of interest) of the data portion of the PPDU before the final symbol, such that the wireless communication device 902-b may utilize the PE duration and the threshold duration from the final symbol to generate the feedback message. Such relaxed time margins, due to the additional symbols used to transmit the data portion of the PPDU, may enable the wireless communication device 902-b to perform relatively higher complexity computations and operations as part of processing the PPDU, which may involve increased hardware processing times or cycles to complete.

To facilitate such PE, the wireless communication devices 902 may negotiate and/or calculate the PE duration (quantity of additional OFDM symbols) according to one or more parameters, such as a bandwidth of a channel utilized to communicate the PPDU, a quantity of spatial streams utilized to transmit the PPDU, a modulation order (QAM order, among other examples. To indicate the PE duration, the wireless communication device 902-a (for example, a transmitting wireless communication device) may transmit a preamble portion of the PPDU that indicates, via an L-SIG field, an U-SIG field, and/or an UHR-SIG field, that PE is applied to the data portion of the PPDU and further indicates, via the L-SIG field, the U-SIG field, and/or the UHR-SIG field a set of parameters that indicate the negotiated PE duration. For example, the set of parameters may include PE duration, a length of the data portion of the PPDU from an end of the preamble, a padding factor (pre-forward error correction padding a-factor), and/or a GI duration (GI length).

In response to receiving the set of parameters, the wireless communication device 902-b may utilize the set of parameters to determine (for example, calculate, identify, or obtain) a total quantity of symbols utilized to transmit the data portion of the PPDU, a quantity of symbols utilized to transmit the set of data bits of the data portion of the PPDU, also referred to as a quantity of data symbols or a quantity of non-trivial symbols, and/or a quantity of symbols utilized to transmit the set of padding bits of the data portion of the PPDU, also referred to as the PE duration.

For example, in scenarios in which the PPDU is transmitted with PE enabled and IM mode disabled (set to an OFF state), the wireless communication device 902-b may obtain the set of parameters via the SIG field of the preamble portion of the PPDU and calculate a quantity of data symbols (N) and the PE duration (X, in microseconds) of the data portion of the PPDU according to the set of parameters. Each symbol may correspond to 12.8 microseconds plus the GI duration (also in microseconds). As such, the wireless communication device 902-b may obtain the total quantity of symbols (total duration) of the data portion of the PPDU, obtain the total quantity of data symbols (M) of the data portion of the PPDU, and obtain the PE duration of the data portion of the PPDU.

As described, the wireless communication devices 902 may support an IM mode, in which one or more pilot tones are interleaved with data tones of an RU allocated for communication of at least the data portion of the PPDU. In such cases, the wireless communication device 902-b may perform additional processing operations and computations, corresponding to the IM mode, within each data symbol, which may add additional time in processing the data portion of the PPDU. It may be desirable to enable longer PE durations at the end of PPDUs, relative to current PE durations applied for PPDUs in which IM mode is disabled, to accommodate for the additional processing timelines caused by the IM at the wireless communication device 902-b.

In some implementations, the wireless communication devices 902 may utilize a quantity of padding symbols (for example, Y, or a quantity of padding OFDM symbols) in the calculation of PE durations for PPDUs in which both PE and IM modes are active (set to the ON state). By doing so, the wireless communication devices 902 may extend a PE duration of PPDUs transmitted according to the IM mode, which may enable the wireless communication device 902 to have an extended period of time to process the data portion of the PPDU, generate the feedback message, among other tasks. As such, the wireless communication device 902-b may have an increased likelihood of fully processing the PPDU prior to generating and transmitting feedback.

In such examples, the quantity of padding symbols may be defined in a standards specification. In some other examples, the wireless communication device 902-a may indicate the quantity of padding symbols utilized for a particular PPDU via the preamble portion of the PPDU. Additionally, or alternatively, the wireless communication devices 902 may negotiate the quantity of padding symbols prior to communication of the PPDU or the quantity of padding symbols may be determined (for example, selected) by the wireless communication device 902-a according to a suggested quantities of padding symbols indicated by the wireless communication device 902-b. Such techniques to indicate the quantity of padding symbols may improve coordination between the wireless communication devices in implementing both PE and IM modes for communication of PPDUs.

For example, at 904, the wireless communication devices 902 may communicate IM mode state information, which may be an example of the IM Mode state information described with reference to FIG. 4. In some examples, the wireless communication device 902-a or the wireless communication device 902-b may transmit a trigger frame that schedules a PPDU. The trigger frame may indicate that the IM mode is set to the ON state. In some other examples, the wireless communication device 902-a may transmit the IM mode state information via a preamble portion of the PPDU, as described with reference to FIG. 4.

At 906, the wireless communication device 902-a may transmit the preamble portion of the PPDU. In some examples, the wireless communication device 902-a may indicate, via a field (SIG field) of the preamble portion of the PPDU, that PE is applied to the PPDU and also indicate a set of parameters corresponding to the PE, such as a GI duration, a padding factor, and/or a length of a set of data bits of the data portion of the PPDU, among other examples.

At 908, the wireless communication device 902-b may determine (for example, calculate, obtain, or identify) a quantity of data symbols and a quantity of symbols utilized for the PE. For example, to determine the quantity of data symbols, the wireless communication device 902-b may identify a quantity of intermediate data symbols (N) according to the GI duration, the length of the set of data bits, the padding factor, and/or the PE indication indicated via the preamble portion of the PPDU. The wireless communication device 902-b may determine the quantity of data symbols to be the difference between the quantity of intermediate data symbols and the quantity of padding symbols (N-Y).

To determine the quantity of symbols utilized for the PE, the wireless communication device 902-b may compute an intermediate PE duration (X) according to the GI duration, the length of the set of data bits, the padding factor, and/or the PE indication indicated via the preamble portion of the PPDU. The wireless communication device 902-b may determine the quantity of symbols utilized for the PE according to the intermediate PE duration (X), the quantity of padding symbols (Y), the GI duration, and a length of a symbol (12.8 microseconds). For example, the wireless communication device 902-b may determine the quantity of symbols utilized for the PE according to: X+Y*(12.8 microseconds+GI duration). In this way, the quantity of symbols utilized for the PE (PE duration for IM mode) may be equal to the original PE for PPDUs in which IM mode is set to the OFF state plus the duration of the quantity of padding symbols (Y).

At 910, the wireless communication device 902-b may receive the data portion of the PPDU via a set of symbols. In such examples, the wireless communication device 902-a may receive the set of data bits via a first subset of the set of symbols and receive a set of padding bits via a second subset of the set of symbols. A quantity of the first subset of the set of symbols may correspond to (be equal to) the quantity of data symbols determined at 908. Similarly, a quantity of the second subset of the set of symbols may correspond to (be equal to) the quantity of symbols utilized for the PE determined at 908.

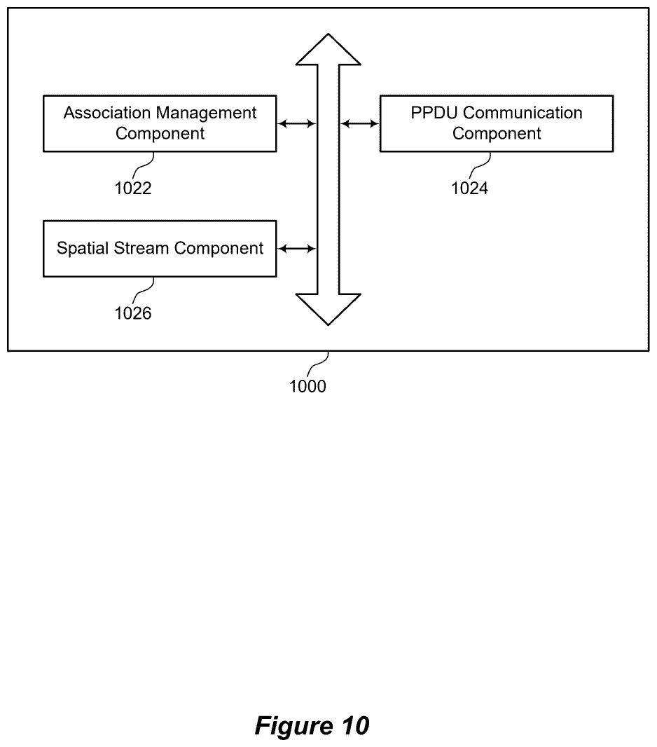

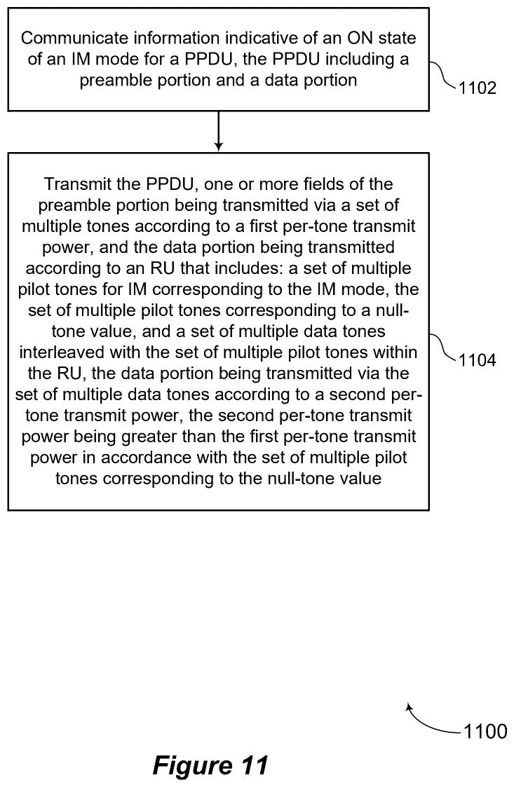

FIG. 10 shows a block diagram of an example wireless communication device 1000 that supports IM signaling techniques for a PPDU. In some examples, the wireless communication device 1000 is configured to perform the processes 1100, 1200, 1300, and 1400 described with reference to FIGS. 11, 12, 13, and 14, respectively. The wireless communication device 1000 may include one or more chips, SoCs, chipsets, packages, components or devices that individually or collectively constitute or include a processing system. The processing system may interface with other components of the wireless communication device 1000 and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1000 may transmit the information output from the chip. In such an example, the second interface may refer to an interface between the processing system of the chip and a reception component, such that the wireless communication device 1000 may receive information that is then passed to the processing system. In some such examples, the first interface also may obtain information, such as from the transmission component, and the second interface also may output information, such as to the reception component.

The processing system of the wireless communication device 1000 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1000 can be configurable or configured for use in an AP or STA, such as the AP 102 or the STA 104 described with reference to FIG. 1. In some other examples, the wireless communication device 1000 can be an AP or STA that includes such a processing system and other components including multiple antennas. The wireless communication device 1000 is capable of transmitting and receiving wireless communications in the form of, for example, wireless packets. For example, the wireless communication device 1000 can be configurable or configured to transmit and receive packets in the form of physical layer PPDUs and MPDUs conforming to one or more of the IEEE 802.11 family of wireless communication protocol standards. In some other examples, the wireless communication device 1000 can be configurable or configured to transmit and receive signals and communications conforming to one or more 3GPP specifications including those for 5G NR or 6G. In some examples, the wireless communication device 1000 also includes or can be coupled with one or more application processors which may be further coupled with one or more other memories. In some examples, the wireless communication device 1000 further includes a user interface (UI) (such as a touchscreen or keypad) and a display, which may be integrated with the UI to form a touchscreen display that is coupled with the processing system. In some examples, the wireless communication device 1000 may further include one or more sensors such as, for example, one or more inertial sensors, accelerometers, temperature sensors, pressure sensors, or altitude sensors, that are coupled with the processing system. In some examples, the wireless communication device 1000 further includes at least one external network interface coupled with the processing system that enables communication with a core network or backhaul network that enables the wireless communication device 1000 to gain access to external networks including the Internet.

The wireless communication device 1000 includes an association management component 1022, a PPDU communication component 1024, and a spatial stream component 1026. Portions of one or more of the association management component 1022, the PPDU communication component 1024, and the spatial stream component 1026 may be implemented at least in part in hardware or firmware. For example, one or more of the association management component 1022, the PPDU communication component 1024, and the spatial stream component 1026 may be implemented at least in part by at least a processor or a modem. In some examples, portions of one or more of the association management component 1022, the PPDU communication component 1024, and the spatial stream component 1026 may be implemented at least in part by a processor and software in the form of processor-executable code stored in memory.

The wireless communication device 1000 may support wireless communication in accordance with examples as disclosed herein. The association management component 1022 is configurable or configured to communicate information indicative of an ON state of an IM mode for a PPDU, the PPDU including a preamble portion and a data portion. The PPDU communication component 1024 is configurable or configured to transmit the PPDU, one or more fields of the preamble portion being transmitted via a set of multiple tones according to a first per-tone transmit power, and the data portion being transmitted according to a RU that includes: a set of multiple pilot tones for IM corresponding to the IM mode, the set of multiple pilot tones corresponding to a null-tone value, and a set of multiple data tones interleaved with the set of multiple pilot tones within the RU, the data portion being transmitted via the set of multiple data tones according to a second per-tone transmit power, the second per-tone transmit power being greater than the first per-tone transmit power in accordance with the set of multiple pilot tones corresponding to the null-tone value.

In some examples, the preamble portion of the PPDU includes a LTF, and the PPDU communication component 1024 is configurable or configured to transmit the LTF via a first subset of the set of multiple tones according to the second per-tone transmit power, where a second subset of tones of the set of multiple tones correspond to the null-tone value over symbols for transmission of the LTF, and where a respective tone of the second subset of tones correspond to a respective tone of the set of multiple pilot tones.

In some examples, the preamble portion of the PPDU includes an LTF, and the PPDU communication component 1024 is configurable or configured to transmit the LTF via the set of multiple tones according to the second per-tone transmit power in accordance with the set of multiple pilot tones corresponding to the null-tone value.

In some examples, an average per-symbol power to transmit the data portion is less than a per-symbol power to transmit the LTF in accordance with the set of multiple pilot tones corresponding to the null-tone value and in accordance with the LTF being transmitted via the set of multiple tones according to the second per-tone transmit power.

In some examples, the second per-tone transmit power is scaled relative to the first per-tone transmitted power according to a first scaling factor. In some examples, the first scaling factor is in accordance with a square root of a second scaling factor.

In some examples, the second scaling factor is in accordance with one or more of a total quantity of tones in the RU, a quantity of the set of multiple pilot tones, a quantity of the set of multiple data tones, or a quantity of CFO tracking tones.

In some examples, the second scaling factor is in accordance with an inverse of the quantity of the set of multiple data tones divided by the total quantity of tones in the RU.

In some examples, the one or more fields of the preamble portion transmitted according to the first per-tone transmit power include an LTF.

In some examples, an average power of each symbol to transmit the data portion is equal to an average power of each symbol to transmit the one or more fields of the preamble portion in accordance with the set of multiple pilot tones corresponding to the null-tone value.

Additionally, or alternatively, the wireless communication device 1000 may support wireless communication in accordance with examples as disclosed herein. The spatial stream component 1026 is configurable or configured to receive first information indicative of a threshold quantity of spatial streams for communications of PPDU in which an IM mode is set to an ON state. In some examples, the association management component 1022 is configurable or configured to communicate second information indicative of the ON state of the IM mode for a PPDU. In some examples, the PPDU communication component 1024 is configurable or configured to transmit the PPDU via a quantity of spatial streams that is less than or equal to the threshold quantity of spatial streams, the PPDU including a data portion that is transmitted according to an RU that includes: a set of multiple pilot tones for IM corresponding to the IM mode, and a set of multiple data tones interleaved with the set of multiple pilot tones within the RU.

In some examples, the first information is transmitted via an ultra-high reliability physical capabilities information element of a management frame.

In some examples, the first information is transmitted via a bit field of the ultra-high reliability physical capabilities information element.

In some examples, the bit field comprises two bits of data, and a first value of the two bits of data indicate the threshold quantity of spatial streams includes a first quantity of spatial streams, a second value of the two bits of data indicates the threshold quantity of spatial streams includes a second quantity of spatial streams, a third value of the two bits of data indicates the threshold quantity of spatial streams includes a third quantity of spatial streams, and a fourth value of the two bits of data indicates the threshold quantity of spatial streams includes a fourth quantity of spatial streams.

In some examples, the threshold quantity of spatial streams is in accordance with one or more of a quantity of receive antennas at a second wireless device, a performance metric of demodulation operations at the second wireless device, or a performance metric of IM operations at the second wireless device.

Additionally, or alternatively, the wireless communication device 1000 may support wireless communication in accordance with examples as disclosed herein. In some examples, the association management component 1022 is configurable or configured to communicate information indicative of an ON state of an IM mode for a PPDU. In some examples, the PPDU communication component 1024 is configurable or configured to receive a preamble portion of the PPDU, the preamble portion of the PPDU indicative of PE being applied to a data portion of the PPDU, the data portion of the PPDU including a set of data bits followed by a set of padding bits in accordance with the PE. In some examples, the PPDU communication component 1024 is configurable or configured to receive the data portion of the PPDU via a set of symbols that is in accordance with the PE, the set of data bits being received via a first subset of the set of symbols and the set of padding bits being received via a second subset of the set of symbols, a quantity of the second subset of the set of symbols being in accordance with a PE duration and a quantity of padding symbols utilized for the PE and the IM mode.

In some examples, a quantity of the first subset of the set of symbols is in accordance with an intermediate quantity of data symbols and the quantity of padding symbols, and the quantity of the second subset of the set of symbols is in accordance with the PE duration, the quantity of padding symbols, a guard interval length between each symbol of the set of symbols, and a length of a symbol.

In some examples, the preamble portion of the PPDU indicates a set of parameters including one or more of the guard interval length, a length of the data portion, or a padding factor. In some examples, the intermediate quantity of data symbols, the quantity of padding symbols, or both are calculated in accordance with the set of parameters.

In some examples, the association management component 1022 is configurable or configured to communicate information indicative of an OFF state of the IM mode for a second PPDU. In some examples, the PPDU communication component 1024 is configurable or configured to receive a second preamble portion of the second PPDU, the second preamble portion indicative of PE being applied to a second data portion of the second PPDU, the second data portion including a second set of data bits followed by a second set of padding bits in accordance with the PE. In some examples, the PPDU communication component 1024 is configurable or configured to receive the second data portion of the second PPDU via a second set of symbols that is in accordance with the PE, the second set of data bits being received via a first subset of the second set of symbols and the second set of padding bits being received via a second subset of the second set of symbols, a quantity of the second subset of the second set of symbols being in accordance with a second PE duration.

In some examples, the preamble portion of the PPDU indicates a set of parameters including one or more of a guard interval length between each symbol of the second set of symbols, a length of the second data portion, or a padding factor, and a quantity of the first subset of the second set of symbols, the quantity of the second subset of the second set of symbols, or both, are calculated in accordance with the set of parameters.

In some examples, to support data portion is further received according to an RU that includes a set of multiple pilot tones for IM correspond to the IM mode, and a set of multiple data tones interleaved with the set of multiple pilot tones within the RU.

Additionally, or alternatively, the wireless communication device 1000 may support wireless communication in accordance with examples as disclosed herein. In some examples, the association management component 1022 is configurable or configured to communicate first information indicative of an ON state of an IM mode for a PPDU, the PPDU including a preamble portion and a data portion. In some examples, the PPDU communication component 1024 is configurable or configured to transmit the preamble portion of the PPDU, the preamble portion indicative of an identifier of a BSS within which the wireless communication device operates. In some examples, the PPDU communication component 1024 is configurable or configured to transmit the data portion of the PPDU according to an RU that includes: a set of multiple data tones, and a set of multiple pilot tones for IM corresponding to the IM mode, the set of multiple pilot tones interleaved with the set of multiple data tones within the RU in accordance with at least the identifier of the BSS and a tone mapping distance that is in accordance with a size of the RU.

In some examples, to interleave the set of multiple pilot tones with the set of multiple data tones, elements of an input vector of an interleaver of the wireless communication device are shifted by a value that is in accordance with the identifier of the BSS, the tone mapping distance, and a length of the input vector, the input vector including the set of multiple pilot tones and the set of multiple data tones.

In some examples, the value is in accordance with a first value multiplied by a second value, the first value is in accordance with the identifier of the BSS modulo the tone mapping distance, and the second value is in accordance with the length of the input vector divided by the tone mapping distance.

In some examples, to interleave the set of multiple pilot tones with the set of multiple data tones, elements of an output vector of an interleaver of the wireless communication device are shifted by a value that is in accordance with the identifier of the BSS modulo the tone mapping distance, the output vector including a first iteration of the set of multiple pilot tones being interleaved with the set of multiple data tones.

FIG. 11 shows a flowchart illustrating an example process 1100 performable by or at a wireless communication device that supports IM signaling techniques for a PPDU. The operations of the process 1100 may be implemented by a wireless communication device or its components as described herein. For example, the process 1100 may be performed by a wireless communication device, such as the wireless communication device 1000 described with reference to FIG. 10, operating as or within a wireless AP or a wireless STA. In some examples, the process 1100 may be performed by a wireless AP or a wireless STA, such as one of the APs 102 or the STAs 104 described with reference to FIG. 1.

In some examples, in 1102, the wireless communication device may communicate information indicative of an ON state of an IM mode for a PPDU, the PPDU including a preamble portion and a data portion. In some implementations, aspects of the operations of 1102 may be performed by an association management component 1022 as described with reference to FIG. 10.

In some examples, in 1104, the wireless communication device may transmit the PPDU, one or more fields of the preamble portion being transmitted via a set of multiple tones according to a first per-tone transmit power, and the data portion being transmitted according to an RU that includes: a set of multiple pilot tones for IM corresponding to the IM mode, the set of multiple pilot tones corresponding to a null-tone value, and a set of multiple data tones interleaved with the set of multiple pilot tones within the RU, the data portion being transmitted via the set of multiple data tones according to a second per-tone transmit power, the second per-tone transmit power being greater than the first per-tone transmit power in accordance with the set of multiple pilot tones corresponding to the null-tone value. In some implementations, aspects of the operations of 1104 may be performed by a PPDU communication component 1024 as described with reference to FIG. 10.

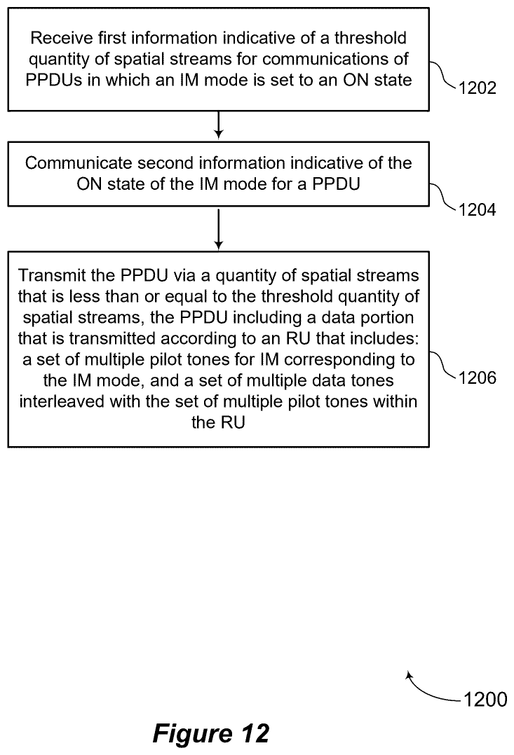

FIG. 12 shows a flowchart illustrating an example process 1200 performable by or at a wireless communication device that supports IM signaling techniques for a PPDU. The operations of the process 1200 may be implemented by a wireless communication device or its components as described herein. For example, the process 1200 may be performed by a wireless communication device, such as the wireless communication device 1000 described with reference to FIG. 10, operating as or within a wireless AP or a wireless STA. In some examples, the process 1200 may be performed by a wireless AP or a wireless STA, such as one of the APs 102 or the STAs 104 described with reference to FIG. 1.

In some examples, in 1202, the wireless communication device may receive first information indicative of a threshold quantity of spatial streams for communications of PPDUs in which an IM mode is set to an ON state. In some implementations, aspects of the operations of 1202 may be performed by a spatial stream component 1026 as described with reference to FIG. 10.

In some examples, in 1204, the wireless communication device may communicate second information indicative of the ON state of the IM mode for a PPDU. In some implementations, aspects of the operations of 1204 may be performed by an association management component 1022 as described with reference to FIG. 10.

In some examples, in 1206, the wireless communication device may transmit the PPDU via a quantity of spatial streams that is less than or equal to the threshold quantity of spatial streams, the PPDU including a data portion that is transmitted according to an RU that includes: a set of multiple pilot tones for IM corresponding to the IM mode, and a set of multiple data tones interleaved with the set of multiple pilot tones within the RU. In some implementations, aspects of the operations of 1206 may be performed by a PPDU communication component 1024 as described with reference to FIG. 10.

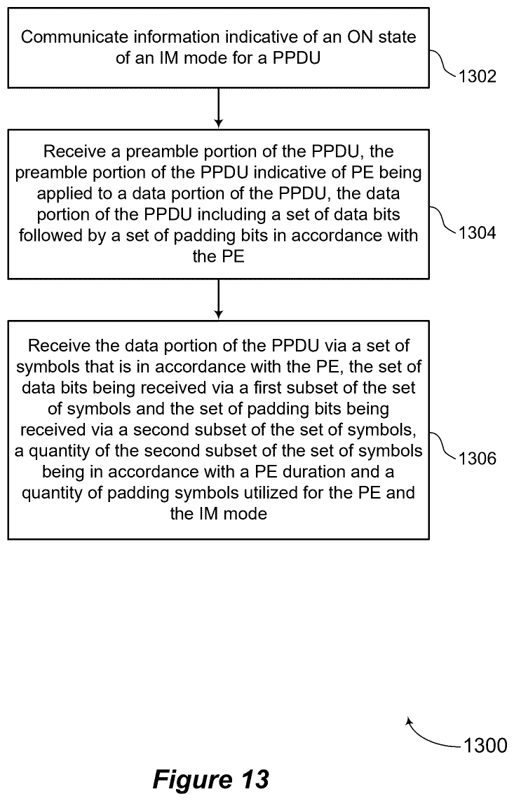

FIG. 13 shows a flowchart illustrating an example process 1300 performable by or at a wireless communication device that supports IM signaling techniques for a PPDU. The operations of the process 1300 may be implemented by a wireless communication device or its components as described herein. For example, the process 1300 may be performed by a wireless communication device, such as the wireless communication device 1000 described with reference to FIG. 10, operating as or within a wireless AP or a wireless STA. In some examples, the process 1300 may be performed by a wireless AP or a wireless STA, such as one of the APs 102 or the STAs 104 described with reference to FIG. 1.

In some examples, in 1302, the wireless communication device may communicate information indicative of an ON state of an IM mode for a PPDU. In some implementations, aspects of the operations of 1302 may be performed by an association management component 1022 as described with reference to FIG. 10.

In some examples, in 1304, the wireless communication device may receive a preamble portion of the PPDU, the preamble portion of the PPDU indicative of PE being applied to a data portion of the PPDU, the data portion of the PPDU including a set of data bits followed by a set of padding bits in accordance with the PE. In some implementations, aspects of the operations of 1304 may be performed by a PPDU communication component 1024 as described with reference to FIG. 10.

In some examples, in 1306, the wireless communication device may receive the data portion of the PPDU via a set of symbols that is in accordance with the PE, the set of data bits being received via a first subset of the set of symbols and the set of padding bits being received via a second subset of the set of symbols, a quantity of the second subset of the set of symbols being in accordance with a PE duration and a quantity of padding symbols utilized for the PE and the IM mode. In some implementations, aspects of the operations of 1306 may be performed by a PPDU communication component 1024 as described with reference to FIG. 10.

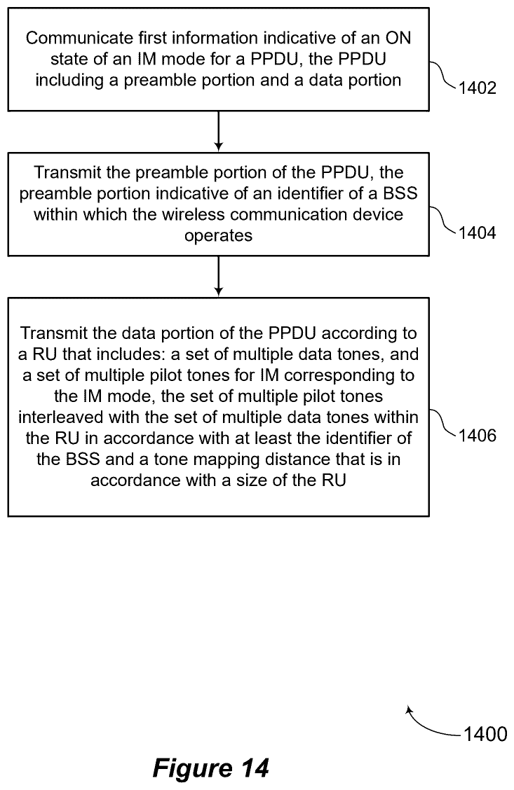

FIG. 14 shows a flowchart illustrating an example process 1400 performable by or at a wireless communication device that supports IM signaling techniques for a PPDU. The operations of the process 1400 may be implemented by a wireless communication device or its components as described herein. For example, the process 1400 may be performed by a wireless communication device, such as the wireless communication device 1000 described with reference to FIG. 10, operating as or within a wireless AP or a wireless STA. In some examples, the process 1400 may be performed by a wireless AP or a wireless STA, such as one of the APs 102 or the STAs 104 described with reference to FIG. 1.

In some examples, in 1402, the wireless communication device may communicate first information indicative of an ON state of an IM mode for a PPDU, the PPDU including a preamble portion and a data portion. In some implementations, aspects of the operations of 1402 may be performed by an association management component 1022 as described with reference to FIG. 10.

In some examples, in 1404, the wireless communication device may transmit the preamble portion of the PPDU, the preamble portion indicative of an identifier of a BSS within which the wireless communication device operates. In some implementations, aspects of the operations of 1404 may be performed by a PPDU communication component 1024 as described with reference to FIG. 10.

In some examples, in 1406, the wireless communication device may transmit the data portion of the PPDU according to an RU that includes: a set of multiple data tones, and a set of multiple pilot tones for IM corresponding to the IM mode, the set of multiple pilot tones interleaved with the set of multiple data tones within the RU in accordance with at least the identifier of the BSS and a tone mapping distance that is in accordance with a size of the RU. In some implementations, aspects of the operations of 1406 may be performed by a PPDU communication component 1024 as described with reference to FIG. 10.

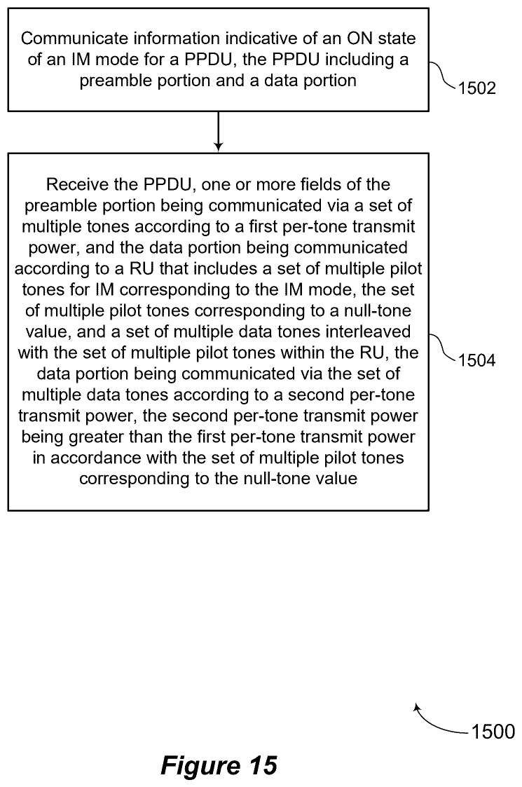

FIG. 15 shows a flowchart illustrating an example process 1500 performable by or at a wireless communication device that supports IM signaling techniques for a PPDU. The operations of the process 1500 may be implemented by a wireless communication device or its components as described herein. For example, the process 1500 may be performed by a wireless communication device, such as the wireless communication device 1000 described with reference to FIG. 10, operating as or within a wireless AP or a wireless STA. In some examples, the process 1500 may be performed by a wireless AP or a wireless STA, such as one of the APs 102 or the STAs 104 described with reference to FIG. 1.

In some examples, in 1502, the wireless communication device may communicate information indicative of an ON state of an IM mode for a PPDU, the PPDU including a preamble portion and a data portion. In some implementations, aspects of the operations of 1502 may be performed by an association management component 1022 as described with reference to FIG. 10.

In some examples, in 1504, the wireless communication device may receive the PPDU, one or more fields of the preamble portion being communicated via a set of multiple tones according to a first per-tone transmit power, and the data portion being communicated according to an RU that includes a set of multiple pilot tones for IM corresponding to the IM mode, the set of multiple pilot tones corresponding to a null-tone value, and a set of multiple data tones interleaved with the set of multiple pilot tones within the RU, the data portion being communicated via the set of multiple data tones according to a second per-tone transmit power, the second per-tone transmit power being greater than the first per-tone transmit power in accordance with the set of multiple pilot tones corresponding to the null-tone value. In some implementations, aspects of the operations of 1504 may be performed by a PPDU communication component 1024 as described with reference to FIG. 10.

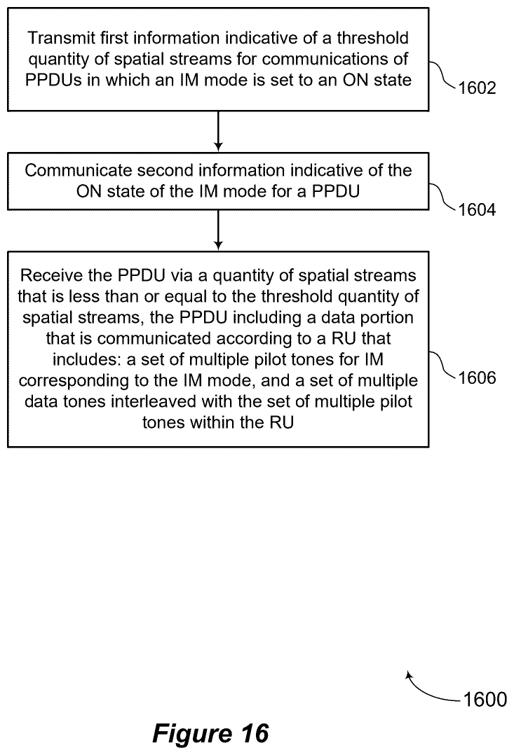

FIG. 16 shows a flowchart illustrating an example process 1600 performable by or at a wireless communication device that supports IM signaling techniques for a PPDU. The operations of the process 1600 may be implemented by a wireless communication device or its components as described herein. For example, the process 1600 may be performed by a wireless communication device, such as the wireless communication device 1000 described with reference to FIG. 10, operating as or within a wireless AP or a wireless STA. In some examples, the process 1600 may be performed by a wireless AP or a wireless STA, such as one of the APs 102 or the STAs 104 described with reference to FIG. 1.

In some examples, in 1602, the wireless communication device may transmit first information indicative of a threshold quantity of spatial streams for communications of PPDUs in which an IM mode is set to an ON state. In some implementations, aspects of the operations of 1602 may be performed by a spatial stream component 1026 as described with reference to FIG. 10.

In some examples, in 1604, the wireless communication device may communicate second information indicative of the ON state of the IM mode for a PPDU. In some implementations, aspects of the operations of 1604 may be performed by an association management component 1022 as described with reference to FIG. 10.

In some examples, in 1606, the wireless communication device may receive the PPDU via a quantity of spatial streams that is less than or equal to the threshold quantity of spatial streams, the PPDU including a data portion that is communicated according to an RU that includes: a set of multiple pilot tones for IM corresponding to the IM mode, and a set of multiple data tones interleaved with the set of multiple pilot tones within the RU. In some implementations, aspects of the operations of 1606 may be performed by a PPDU communication component 1024 as described with reference to FIG. 10.

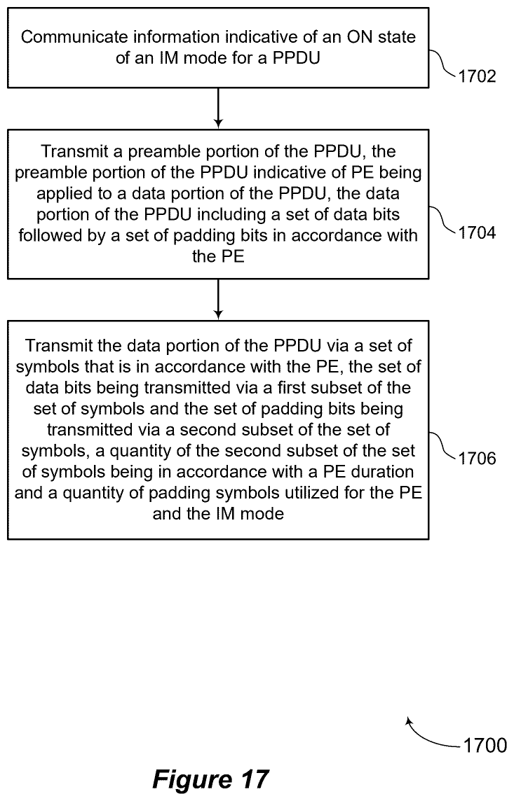

FIG. 17 shows a flowchart illustrating an example process 1700 performable by or at a wireless communication device that supports IM signaling techniques for a PPDU. The operations of the process 1700 may be implemented by a wireless communication device or its components as described herein. For example, the process 1700 may be performed by a wireless communication device, such as the wireless communication device 1000 described with reference to FIG. 10, operating as or within a wireless AP or a wireless STA. In some examples, the process 1700 may be performed by a wireless AP or a wireless STA, such as one of the APs 102 or the STAs 104 described with reference to FIG. 1.

In some examples, in 1702, the wireless communication device may communicate information indicative of an ON state of an IM mode for a PPDU. In some implementations, aspects of the operations of 1702 may be performed by an association management component 1022 as described with reference to FIG. 10.

In some examples, in 1704, the wireless communication device may transmit a preamble portion of the PPDU, the preamble portion of the PPDU indicative of PE being applied to a data portion of the PPDU, the data portion of the PPDU including a set of data bits followed by a set of padding bits in accordance with the PE. In some implementations, aspects of the operations of 1704 may be performed by a PPDU communication component 1024 as described with reference to FIG. 10.

In some examples, in 1706, the wireless communication device may transmit the data portion of the PPDU via a set of symbols that is in accordance with the PE, the set of data bits being transmitted via a first subset of the set of symbols and the set of padding bits being transmitted via a second subset of the set of symbols, a quantity of the second subset of the set of symbols being in accordance with a PE duration and a quantity of padding symbols utilized for the PE and the IM mode. In some implementations, aspects of the operations of 1706 may be performed by a PPDU communication component 1024 as described with reference to FIG. 10.

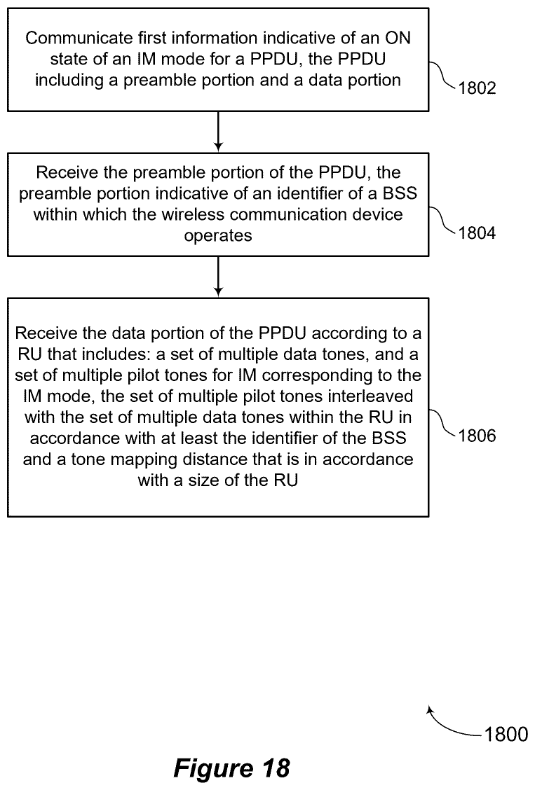

FIG. 18 shows a flowchart illustrating an example process 1800 performable by or at a wireless communication device that supports IM signaling techniques for a PPDU. The operations of the process 1800 may be implemented by a wireless communication device or its components as described herein. For example, the process 1800 may be performed by a wireless communication device, such as the wireless communication device 1000 described with reference to FIG. 10, operating as or within a wireless AP or a wireless STA. In some examples, the process 1800 may be performed by a wireless AP or a wireless STA, such as one of the APs 102 or the STAs 104 described with reference to FIG. 1.

In some examples, in 1802, the wireless communication device may communicate first information indicative of an ON state of an IM mode for a PPDU, the PPDU including a preamble portion and a data portion. In some implementations, aspects of the operations of 1802 may be performed by an association management component 1022 as described with reference to FIG. 10.

In some examples, in 1804, the wireless communication device may receive the preamble portion of the PPDU, the preamble portion indicative of an identifier of a BSS within which the wireless communication device operates. In some implementations, aspects of the operations of 1804 may be performed by a PPDU communication component 1024 as described with reference to FIG. 10.

In some examples, in 1806, the wireless communication device may receive the data portion of the PPDU according to an RU that includes: a set of multiple data tones, and a set of multiple pilot tones for IM corresponding to the IM mode, the set of multiple pilot tones interleaved with the set of multiple data tones within the RU in accordance with at least the identifier of the BSS and a tone mapping distance that is in accordance with a size of the RU. In some implementations, aspects of the operations of 1806 may be performed by a PPDU communication component 1024 as described with reference to FIG. 10.

Implementation examples are described in the following numbered clauses:

The following provides an overview of aspects of the present disclosure:

Aspect 1: A method for wireless communication by a wireless communication device, comprising: communicating information indicative of an ON state of an IM mode for a PPDU, the PPDU comprising a preamble portion and a data portion; and transmitting the PPDU, one or more fields of the preamble portion being transmitted via a plurality of tones according to a first per-tone transmit power, and the data portion being transmitted according to a RU that comprises: a plurality of pilot tones for IM corresponding to the IM mode, the plurality of pilot tones corresponding to a null-tone value, and a plurality of data tones interleaved with the plurality of pilot tones within the RU, the data portion being transmitted via the plurality of data tones according to a second per-tone transmit power, the second per-tone transmit power being greater than the first per-tone transmit power in accordance with the plurality of pilot tones corresponding to the null-tone value.

Aspect 2: The method of aspect 1, wherein the preamble portion of the PPDU comprises a LTF, the method further comprising: transmitting the LTF via a first subset of the plurality of tones according to the second per-tone transmit power, wherein a second subset of tones of the plurality of tones correspond to the null-tone value over symbols for transmission of the LTF, and wherein a respective tone of the second subset of tones correspond to a respective tone of the plurality of pilot tones.

Aspect 3: The method of aspect 1, wherein the preamble portion of the PPDU comprises a LTF, the method further comprising: transmitting the LTF via the plurality of tones according to the second per-tone transmit power in accordance with the plurality of pilot tones corresponding to the null-tone value.

Aspect 4: The method of aspect 3, wherein an average per-symbol power to transmit the data portion is less than a per-symbol power to transmit the LTF in accordance with the plurality of pilot tones corresponding to the null-tone value and in accordance with the LTF being transmitted via the plurality of tones according to the second per-tone transmit power.

Aspect 5: The method of any of aspects 1 through 4, wherein the second per-tone transmit power is scaled relative to the first per-tone transmit power according to a first scaling factor, and the first scaling factor is in accordance with a square root of a second scaling factor.

Aspect 6: The method of aspect 5, wherein the second scaling factor is in accordance with one or more of a total quantity of tones in the RU, a quantity of the plurality of pilot tones, a quantity of the plurality of data tones, or a quantity of carrier frequency offset tracking tones.

Aspect 7: The method of aspect 6, wherein the second scaling factor is in accordance with an inverse of the quantity of the plurality of data tones divided by the total quantity of tones in the RU.

Aspect 8: The method of aspect 1, wherein the one or more fields of the preamble portion transmitted according to the first per-tone transmit power comprise a LTF.

Aspect 9: The method of any of aspects 1 through 8, wherein an average power of each symbol to transmit the data portion is equal to an average power of each symbol to transmit the one or more fields of the preamble portion in accordance with the plurality of pilot tones corresponding to the null-tone value.

Aspect 10: A method for wireless communication by a wireless communication device, comprising: receiving first information indicative of a threshold quantity of spatial streams for communications of PPDUs in which an IM mode is set to an ON state; communicating second information indicative of the ON state of the IM mode for a PPDU; and transmitting the PPDU via a quantity of spatial streams that is less than or equal to the threshold quantity of spatial streams, the PPDU comprising a data portion that is transmitted according to a RU that comprises: a plurality of pilot tones for IM corresponding to the IM mode, and a plurality of data tones interleaved with the plurality of pilot tones within the RU.

Aspect 11: The method of aspect 10, wherein the first information is transmitted via an ultra-high reliability physical capabilities information element of a management frame.

Aspect 12: The method of aspect 11, wherein the first information is transmitted via a bit field of the ultra-high reliability physical capabilities information element.

Aspect 13: The method of aspect 12, wherein the bit field comprises two bits of data, and wherein: a first value of the two bits of data indicates the threshold quantity of spatial streams comprises a first quantity of spatial streams, a second value of the two bits of data indicates the threshold quantity of spatial streams comprises a second quantity of spatial streams, a third value of the two bits of data indicates the threshold quantity of spatial streams comprises a third quantity of spatial streams, and a fourth value of the two bits of data indicates the threshold quantity of spatial streams comprises a fourth quantity of spatial streams.

Aspect 14: The method of any of aspects 10 through 13, wherein the threshold quantity of spatial streams is in accordance with one or more of a quantity of receive antennas at a second wireless device, a performance metric of demodulation operations at the second wireless device, or a performance metric of IM operations at the second wireless device.

Aspect 15: A method for wireless communication by a wireless communication device, comprising: communicating information indicative of an ON state of an IM mode for a PPDU; receiving a preamble portion of the PPDU, the preamble portion of the PPDU indicative of PE being applied to a data portion of the PPDU, the data portion of the PPDU comprising a set of data bits followed by a set of padding bits in accordance with the PE; and receiving the data portion of the PPDU via a set of symbols that is in accordance with the PE, the set of data bits being received via a first subset of the set of symbols and the set of padding bits being received via a second subset of the set of symbols, a quantity of the second subset of the set of symbols being in accordance with a PE duration and a quantity of padding symbols utilized for the PE and the IM mode.

Aspect 16: The method of aspect 15, wherein a quantity of the first subset of the set of symbols is in accordance with an intermediate quantity of data symbols and the quantity of padding symbols, and the quantity of the second subset of the set of symbols is in accordance with the PE duration, the quantity of padding symbols, a guard interval length between each symbol of the set of symbols, and a length of a symbol.

Aspect 17: The method of aspect 16, wherein the preamble portion of the PPDU indicates a set of parameters comprising one or more of the guard interval length, a length of the data portion, or a padding factor, and the intermediate quantity of data symbols, the quantity of padding symbols, or both are calculated in accordance with the set of parameters.

Aspect 18: The method of any of aspects 15 through 17, further comprising: communicating information indicative of an OFF state of the IM mode for a second PPDU; receiving a second preamble portion of the second PPDU, the second preamble portion indicative of PE being applied to a second data portion of the second PPDU, the second data portion comprising a second set of data bits followed by a second set of padding bits in accordance with the PE; and receiving the second data portion of the second PPDU via a second set of symbols that is in accordance with the PE, the second set of data bits being received via a first subset of the second set of symbols and the second set of padding bits being received via a second subset of the second set of symbols, a quantity of the second subset of the second set of symbols being in accordance with a second PE duration.

Aspect 19: The method of aspect 18, wherein the preamble portion of the PPDU indicates a set of parameters comprising one or more of a guard interval length between each symbol of the second set of symbols, a length of the second data portion, or a padding factor, and a quantity of the first subset of the second set of symbols, the quantity of the second subset of the second set of symbols, or both, are calculated in accordance with the set of parameters.

Aspect 20: The method of any of aspects 15 through 19, wherein the data portion is further received according to a RU that comprises: a plurality of pilot tones for IM corresponding to the IM mode, and a plurality of data tones interleaved with the plurality of pilot tones within the RU.

Aspect 21: A method for wireless communication by a wireless communication device, comprising: communicating first information indicative of an ON state of an IM mode for a PPDU, the PPDU comprising a preamble portion and a data portion; transmitting the preamble portion of the PPDU, the preamble portion indicative of an identifier of a BSS within which the wireless communication device operates; and transmitting the data portion of the PPDU according to a RU that comprises: a plurality of data tones, and a plurality of pilot tones for IM corresponding to the IM mode, the plurality of pilot tones interleaved with the plurality of data tones within the RU in accordance with at least the identifier of the BSS and a tone mapping distance that is in accordance with a size of the RU.

Aspect 22: The method of aspect 21, wherein to interleave the plurality of pilot tones with the plurality of data tones, elements of an input vector of an interleaver of the wireless communication device are shifted by a value that is in accordance with the identifier of the BSS, the tone mapping distance, and a length of the input vector, the input vector comprising the plurality of pilot tones and the plurality of data tones.

Aspect 23: The method of aspect 22, wherein the value is in accordance with a first value multiplied by a second value, the first value is in accordance with the identifier of the BSS modulo the tone mapping distance, and the second value is in accordance with the length of the input vector divided by the tone mapping distance.

Aspect 24: The method of aspect 21, wherein to interleave the plurality of pilot tones with the plurality of data tones, elements of an output vector of an interleaver of the wireless communication device are shifted by a value that is in accordance with the identifier of the BSS modulo the tone mapping distance, the output vector comprising a first iteration of the plurality of pilot tones being interleaved with the plurality of data tones.

Aspect 25: A method for wireless communication by a wireless communication device, comprising: communicating information indicative of an ON state of an IM mode for a PPDU, the PPDU comprising a preamble portion and a data portion; and receiving the PPDU, one or more fields of the preamble portion being communicated via a plurality of tones according to a first per-tone transmit power, and the data portion being communicated according to a RU that comprises a plurality of pilot tones for IM corresponding to the IM mode, the plurality of pilot tones corresponding to a null-tone value, and a plurality of data tones interleaved with the plurality of pilot tones within the RU, the data portion being communicated via the plurality of data tones according to a second per-tone transmit power, the second per-tone transmit power being greater than the first per-tone transmit power in accordance with the plurality of pilot tones corresponding to the null-tone value.

Aspect 26: The method of aspect 25, wherein the preamble portion of the PPDU comprises a LTF, the method further comprising: receiving the LTF via a first subset of the plurality of tones according to the second per-tone transmit power, wherein a second subset of tones of the plurality of tones correspond to the null-tone value over symbols for communication of the LTF, and wherein a respective tone of the second subset of tones correspond to a respective tone of the plurality of pilot tones.

Aspect 27: The method of aspect 25, wherein the preamble portion of the PPDU comprises a LTF, the method further comprising: receiving the LTF via the plurality of tones according to the second per-tone transmit power in accordance with the plurality of pilot tones corresponding to the null-tone value.

Aspect 28: The method of aspect 27, wherein an average per-symbol power to communicate the data portion is less than a per-symbol power to communicate the LTF in accordance with the plurality of pilot tones corresponding to the null-tone value and in accordance with the LTF being communicated via the plurality of tones according to the second per-tone transmit power.

Aspect 29: The method of any of aspects 25 through 28, wherein the second per-tone transmit power is scaled relative to the first per-tone transmit power according to a first scaling factor, and the first scaling factor is in accordance with a square root of a second scaling factor.

Aspect 30: The method of aspect 29, wherein the second scaling factor is in accordance with one or more of a total quantity of tones in the RU, a quantity of the plurality of pilot tones, a quantity of the plurality of data tones, or a quantity of carrier frequency offset tracking tones.

Aspect 31: The method of aspect 30, wherein the second scaling factor is in accordance with an inverse of the quantity of the plurality of data tones divided by the total quantity of tones in the RU.

Aspect 32: The method of aspect 25, wherein the one or more fields of the preamble portion communicated according to the first per-tone transmit power comprise a LTF.

Aspect 33: The method of aspect 32, wherein to receive the data portion of the PPDU, one or more per-tone channel estimations obtained using the LTF are scaled according to a scaling factor in accordance with the LTF being communicated according to the first per-tone transmit power, and the second per-tone transmit power is scaled relative to the first per-tone transmit power by the scaling factor.

Aspect 34: The method of any of aspects 25 through 33, wherein an average power of each symbol to communicate the data portion is equal to an average power of each symbol to transmit the one or more fields of the preamble portion in accordance with the plurality of pilot tones corresponding to the null-tone value.

Aspect 35: A method for wireless communication by a wireless communication device, comprising: transmitting first information indicative of a threshold quantity of spatial streams for communications of PPDUs in which an IM mode is set to an ON state; communicating second information indicative of the ON state of the IM mode for a PPDU; and receiving the PPDU via a quantity of spatial streams that is less than or equal to the threshold quantity of spatial streams, the PPDU comprising a data portion that is communicated according to a RU that comprises: a plurality of pilot tones for IM corresponding to the IM mode, and a plurality of data tones interleaved with the plurality of pilot tones within the RU.

Aspect 36: The method of aspect 35, wherein the first information is received via an ultra-high reliability physical capabilities information element of a management frame.

Aspect 37: The method of aspect 36, wherein the first information is received via a bit field of the ultra-high reliability physical capabilities information element.

Aspect 38: The method of aspect 37, wherein the bit field comprises two bits of data, and wherein: a first value of the two bits of data indicates the threshold quantity of spatial streams comprises a first quantity of spatial streams, a second value of the two bits of data indicates the threshold quantity of spatial streams comprises a second quantity of spatial streams, a third value of the two bits of data indicates the threshold quantity of spatial streams comprises a third quantity of spatial streams, and a fourth value of the two bits of data indicates the threshold quantity of spatial streams comprises a fourth quantity of spatial streams.

Aspect 39: The method of any of aspects 35 through 38, wherein the threshold quantity of spatial streams is in accordance with one or more of a quantity of receive antennas at the wireless communication device, a performance metric of demodulation operations at the wireless communication device, or a performance metric of IM operations at the wireless communication device.

Aspect 40: A method for wireless communication by a wireless communication device, comprising: communicating information indicative of an ON state of an IM mode for a PPDU; transmitting a preamble portion of the PPDU, the preamble portion of the PPDU indicative of PE being applied to a data portion of the PPDU, the data portion of the PPDU comprising a set of data bits followed by a set of padding bits in accordance with the PE; and transmitting the data portion of the PPDU via a set of symbols that is in accordance with the PE, the set of data bits being transmitted via a first subset of the set of symbols and the set of padding bits being transmitted via a second subset of the set of symbols, a quantity of the second subset of the set of symbols being in accordance with a PE duration and a quantity of padding symbols utilized for the PE and the IM mode.

Aspect 41: The method of aspect 40, wherein a quantity of the first subset of the set of symbols is in accordance with an intermediate quantity of data symbols and the quantity of padding symbols, and the quantity of the second subset of the set of symbols is in accordance with the PE duration, the quantity of padding symbols, a guard interval length between each symbol of the set of symbols, and a length of a symbol.

Aspect 42: The method of aspect 41, wherein the preamble portion of the PPDU indicates a set of parameters comprising one or more of the guard interval length, a length of the data portion, or a padding factor, and the intermediate quantity of data symbols, the quantity of padding symbols, or both are calculated in accordance with the set of parameters.

Aspect 43: The method of any of aspects 40 through 42, further comprising: communicating information indicative of an OFF state of the IM mode for a second PPDU; transmitting a second preamble portion of the second PPDU, the second preamble portion indicative of PE being applied to a second data portion of the second PPDU, the second data portion comprising a second set of data bits followed by a second set of padding bits in accordance with the PE; and transmitting the second data portion of the second PPDU via a second set of symbols that is in accordance with the PE, the second set of data bits being transmitted via a first subset of the second set of symbols and the second set of padding bits being transmitted via a second subset of the second set of symbols, a quantity of the second subset of the second set of symbols being in accordance with a second PE duration.

Aspect 44: The method of aspect 43, wherein the preamble portion of the PPDU indicates a set of parameters comprising one or more of a guard interval length between each symbol of the second set of symbols, a length of the second data portion, or a padding factor, and a quantity of the first subset of the second set of symbols, the quantity of the second subset of the second set of symbols, or both, are calculated in accordance with the set of parameters.

Aspect 45: The method of any of aspects 40 through 44, wherein the data portion is further transmitted according to a RU that comprises: a plurality of pilot tones for IM corresponding to the IM mode, and a plurality of data tones interleaved with the plurality of pilot tones within the RU.

Aspect 46: A method for wireless communication by a wireless communication device, comprising: communicating first information indicative of an ON state of an IM mode for a PPDU, the PPDU comprising a preamble portion and a data portion; receiving the preamble portion of the PPDU, the preamble portion indicative of an identifier of a BSS within which the wireless communication device operates; and receiving the data portion of the PPDU according to a RU that comprises: a plurality of data tones, and a plurality of pilot tones for IM corresponding to the IM mode, the plurality of pilot tones interleaved with the plurality of data tones within the RU in accordance with at least the identifier of the BSS and a tone mapping distance that is in accordance with a size of the RU.

Aspect 47: The method of aspect 46, wherein the plurality of pilot tones are interleaved according to the identifier of the BSS, the tone mapping distance, and a length of an input vector of an interleaver at a second wireless communication device, the input vector comprising the plurality of pilot tones and the plurality of data tones.

Aspect 48: The method of any of aspects 46 through 47, wherein the plurality of pilot tones are interleaved according to a shift value that is in accordance with the identifier of the BSS modulo the tone mapping distance.

Aspect 49: A wireless communication device for wireless communication, comprising a processing system that includes processor circuitry and memory circuitry that stores code, the processing system configured to cause the wireless communication device to perform a method of any of aspects 1 through 9.

Aspect 50: A wireless communication device for wireless communication, comprising at least one means for performing a method of any of aspects 1 through 9.

Aspect 51: A non-transitory computer-readable medium storing code for wireless communication, the code comprising instructions executable by one or more processors to perform a method of any of aspects 1 through 9.

Aspect 52: A wireless communication device for wireless communication, comprising a processing system that includes processor circuitry and memory circuitry that stores code, the processing system configured to cause the wireless communication device to perform a method of any of aspects 10 through 14.

Aspect 53: A wireless communication device for wireless communication, comprising at least one means for performing a method of any of aspects 10 through 14.

Aspect 54: A non-transitory computer-readable medium storing code for wireless communication, the code comprising instructions executable by one or more processors to perform a method of any of aspects 10 through 14.

Aspect 55: A wireless communication device for wireless communication, comprising a processing system that includes processor circuitry and memory circuitry that stores code, the processing system configured to cause the wireless communication device to perform a method of any of aspects 15 through 20.

Aspect 56: A wireless communication device for wireless communication, comprising at least one means for performing a method of any of aspects 15 through 20.

Aspect 57: A non-transitory computer-readable medium storing code for wireless communication, the code comprising instructions executable by one or more processors to perform a method of any of aspects 15 through 20.

Aspect 58: A wireless communication device for wireless communication, comprising a processing system that includes processor circuitry and memory circuitry that stores code, the processing system configured to cause the wireless communication device to perform a method of any of aspects 21 through 24.

Aspect 59: A wireless communication device for wireless communication, comprising at least one means for performing a method of any of aspects 21 through 24.

Aspect 60: A non-transitory computer-readable medium storing code for wireless communication, the code comprising instructions executable by one or more processors to perform a method of any of aspects 21 through 24.

Aspect 61: A wireless communication device for wireless communication, comprising a processing system that includes processor circuitry and memory circuitry that stores code, the processing system configured to cause the wireless communication device to perform a method of any of aspects 25 through 34.

Aspect 62: A wireless communication device for wireless communication, comprising at least one means for performing a method of any of aspects 25 through 34.

Aspect 63: A non-transitory computer-readable medium storing code for wireless communication, the code comprising instructions executable by one or more processors to perform a method of any of aspects 25 through 34.

Aspect 64: A wireless communication device for wireless communication, comprising a processing system that includes processor circuitry and memory circuitry that stores code, the processing system configured to cause the wireless communication device to perform a method of any of aspects 35 through 39.

Aspect 65: A wireless communication device for wireless communication, comprising at least one means for performing a method of any of aspects 35 through 39.

Aspect 66: A non-transitory computer-readable medium storing code for wireless communication, the code comprising instructions executable by one or more processors to perform a method of any of aspects 35 through 39.

Aspect 67: A wireless communication device for wireless communication, comprising a processing system that includes processor circuitry and memory circuitry that stores code, the processing system configured to cause the wireless communication device to perform a method of any of aspects 40 through 45.

Aspect 68: A wireless communication device for wireless communication, comprising at least one means for performing a method of any of aspects 40 through 45.

Aspect 69: A non-transitory computer-readable medium storing code for wireless communication, the code comprising instructions executable by one or more processors to perform a method of any of aspects 40 through 45.

Aspect 70: A wireless communication device for wireless communication, comprising a processing system that includes processor circuitry and memory circuitry that stores code, the processing system configured to cause the wireless communication device to perform a method of any of aspects 46 through 48.

Aspect 71: A wireless communication device for wireless communication, comprising at least one means for performing a method of any of aspects 46 through 48.

Aspect 72: A non-transitory computer-readable medium storing code for wireless communication, the code comprising instructions executable by one or more processors to perform a method of any of aspects 46 through 48.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A wireless communication device, comprising:
a processing system that includes processor circuitry and memory circuitry that stores code, the processing system configured to cause the wireless communication device to:
communicate information indicative of an ON state of an interference mitigation mode for a physical layer protocol data unit (PPDU), the PPDU comprising a preamble portion and a data portion; and
transmit the PPDU, one or more fields of the preamble portion being transmitted via a plurality of tones according to a first per-tone transmit power, and the data portion being transmitted according to a resource unit (RU) that comprises:
a plurality of pilot tones for interference mitigation corresponding to the interference mitigation mode, the plurality of pilot tones corresponding to a null-tone value, and
a plurality of data tones interleaved with the plurality of pilot tones within the RU, the data portion being transmitted via the plurality of data tones according to a second per-tone transmit power, the second per-tone transmit power being greater than the first per-tone transmit power in accordance with the plurality of pilot tones corresponding to the null-tone value.

2. The wireless communication device of claim 1, wherein the preamble portion of the PPDU comprises a long training field, and the processing system is further configured to cause the wireless communication device to transmit the long training field via a first subset of the plurality of tones according to the second per-tone transmit power, wherein a second subset of tones of the plurality of tones correspond to the null-tone value over symbols for transmission of the long training field, and wherein a respective tone of the second subset of tones correspond to a respective tone of the plurality of pilot tones.

3. The wireless communication device of claim 1, wherein the preamble portion of the PPDU comprises a long training field, and the processing system is further configured to cause the wireless communication device to transmit the long training field via the plurality of tones according to the second per-tone transmit power in accordance with the plurality of pilot tones corresponding to the null-tone value.

4. The wireless communication device of claim 3, wherein an average per-symbol power to transmit the data portion is less than a per-symbol power to transmit the long training field in accordance with the plurality of pilot tones corresponding to the null-tone value and in accordance with the long training field being transmitted via the plurality of tones according to the second per-tone transmit power.

5. The wireless communication device of claim 1, wherein:
the second per-tone transmit power is scaled relative to the first per-tone transmit power according to a first scaling factor, and
the first scaling factor is in accordance with the square root of a second scaling factor.

6. The wireless communication device of claim 5, wherein the second scaling factor is in accordance with one or more of a total quantity of tones in the RU, a quantity of the plurality of pilot tones, a quantity of the plurality of data tones, or a quantity of carrier frequency offset tracking tones.

7. The wireless communication device of claim 6, wherein the second scaling factor is in accordance with an inverse of the quantity of the plurality of data tones divided by the total quantity of tones in the RU.

8. The wireless communication device of claim 1, wherein the one or more fields of the preamble portion transmitted according to the first per-tone transmit power comprise a long training field.

9. The wireless communication device of claim 1, wherein an average power of each symbol to transmit the data portion is equal to an average power of each symbol to transmit the one or more fields of the preamble portion in accordance with the plurality of pilot tones corresponding to the null-tone value.

10. A wireless communication device, comprising:
a processing system that includes processor circuitry and memory circuitry that stores code, the processing system configured to cause the wireless communication device to:
receive first information indicative of a threshold quantity of spatial streams for communications of physical layer protocol data units (PPDUs) in which an interference mitigation mode is set to an ON state;
communicate second information indicative of the ON state of the interference mitigation mode for a PPDU; and
transmit the PPDU via a quantity of spatial streams that is less than or equal to the threshold quantity of spatial streams, the PPDU comprising a data portion that is transmitted according to a resource unit (RU) that comprises:
a plurality of pilot tones for interference mitigation corresponding to the interference mitigation mode, and
a plurality of data tones interleaved with the plurality of pilot tones within the RU.

11. The wireless communication device of claim 10, wherein the first information is transmitted via an ultra-high reliability physical capabilities information element of a management frame.

12. The wireless communication device of claim 11, wherein the first information is transmitted via a bit field of the ultra-high reliability physical capabilities information element.

13. The wireless communication device of claim 12, wherein the bit field comprises two bits of data, and wherein:
a first value of the two bits of data indicates the threshold quantity of spatial streams comprises a first quantity of spatial streams,
a second value of the two bits of data indicates the threshold quantity of spatial streams comprises a second quantity of spatial streams,
a third value of the two bits of data indicates the threshold quantity of spatial streams comprises a third quantity of spatial streams, and
a fourth value of the two bits of data indicates the threshold quantity of spatial streams comprises a fourth quantity of spatial streams.

14. The wireless communication device of claim 10, wherein the threshold quantity of spatial streams is in accordance with one or more of a quantity of receive antennas at a second wireless device, a performance metric of demodulation operations at the second wireless device, or a performance metric of interference mitigation operations at the second wireless device.

15. A wireless communication device, comprising:
a processing system that includes processor circuitry and memory circuitry that stores code, the processing system configured to cause the wireless communication device to:
communicate information indicative of an ON state of an interference mitigation mode for a physical layer protocol data unit (PPDU);
receive a preamble portion of the PPDU, the preamble portion of the PPDU indicative of packet extension being applied to a data portion of the PPDU, the data portion of the PPDU comprising a set of data bits followed by a set of padding bits in accordance with the packet extension; and
receive the data portion of the PPDU via a set of symbols that is in accordance with the packet extension, the set of data bits being received via a first subset of the set of symbols and the set of padding bits being received via a second subset of the set of symbols, a quantity of the second subset of the set of symbols being in accordance with a packet extension duration and a quantity of padding symbols utilized for the packet extension and the interference mitigation mode.

16. The wireless communication device of claim 15, wherein:
a quantity of the first subset of the set of symbols is in accordance with an intermediate quantity of data symbols and the quantity of padding symbols, and
the quantity of the second subset of the set of symbols is in accordance with the packet extension duration, the quantity of padding symbols, a guard interval length between each symbol of the set of symbols, and a length of a symbol.

17. The wireless communication device of claim 16, wherein:
the preamble portion of the PPDU indicates a set of parameters comprising one or more of the guard interval length, a length of the data portion, or a padding factor, and
the intermediate quantity of data symbols, the quantity of padding symbols, or both are calculated in accordance with the set of parameters.

18. The wireless communication device of claim 15, wherein the processing system is further configured to cause the wireless communication device to:
communicate information indicative of an OFF state of the interference mitigation mode for a second PPDU;
receive a second preamble portion of the second PPDU, the second preamble portion indicative of packet extension being applied to a second data portion of the second PPDU, the second data portion comprising a second set of data bits followed by a second set of padding bits in accordance with the packet extension; and
receive the second data portion of the second PPDU via a second set of symbols that is in accordance with the packet extension, the second set of data bits being received via a first subset of the second set of symbols and the second set of padding bits being received via a second subset of the second set of symbols, a quantity of the second subset of the second set of symbols being in accordance with a second packet extension duration.

19. The wireless communication device of claim 18, wherein:
the preamble portion of the PPDU indicates a set of parameters comprising one or more of a guard interval length between each symbol of the second set of symbols, a length of the second data portion, or a padding factor, and
a quantity of the first subset of the second set of symbols, the quantity of the second subset of the second set of symbols, or both, are calculated in accordance with the set of parameters.

20. The wireless communication device of claim 15, wherein the data portion is further received according to a resource unit (RU) that comprises:
a plurality of pilot tones for interference mitigation correspond to the interference mitigation mode, and
a plurality of data tones interleaved with the plurality of pilot tones within the RU.

21. A wireless communication device, comprising:
a processing system that includes processor circuitry and memory circuitry that stores code, the processing system configured to cause the wireless communication device to:
communicate information indicative of an ON state of an interference mitigation mode for a physical layer protocol data unit (PPDU), the PPDU comprising a preamble portion and a data portion; and
receive the PPDU, one or more fields of the preamble portion being communicated via a plurality of tones according to a first per-tone transmit power, and the data portion being communicated according to a resource unit (RU) that comprises a plurality of pilot tones for interference mitigation corresponding to the interference mitigation mode, the plurality of pilot tones corresponding to a null-tone value, and a plurality of data tones interleaved with the plurality of pilot tones within the RU, the data portion being communicated via the plurality of data tones according to a second per-tone transmit power, the second per-tone transmit power being greater than the first per-tone transmit power in accordance with the plurality of pilot tones corresponding to the null-tone value.

22. The wireless communication device of claim 21, wherein the preamble portion of the PPDU comprises a long training field, and the processing system is further configured to cause the wireless communication device to:
receive the long training field via a first subset of the plurality of tones according to the second per-tone transmit power, wherein a second subset of tones of the plurality of tones correspond to the null-tone value over symbols for communication of the long training field, and wherein a respective tone of the second subset of tones correspond to a respective tone of the plurality of pilot tones.

23. The wireless communication device of claim 21, wherein the preamble portion of the PPDU comprises a long training field, and the processing system is further configured to cause the wireless communication device to:
receive the long training field via the plurality of tones according to the second per-tone transmit power in accordance with the plurality of pilot tones corresponding to the null-tone value.

24. The wireless communication device of claim 23, wherein an average per-symbol power to communicate the data portion is less than a per-symbol power to communicate the long training field in accordance with the plurality of pilot tones corresponding to the null-tone value and in accordance with the long training field being communicated via the plurality of tones according to the second per-tone transmit power.

25. The wireless communication device of claim 21, wherein:
the second per-tone transmit power is scaled relative to the first per-tone transmit power according to a first scaling factor, and
the first scaling factor is in accordance with a square root of a second scaling factor.

26. The wireless communication device of claim 25, wherein the second scaling factor is in accordance with one or more of a total quantity of tones in the RU, a quantity of the plurality of pilot tones, a quantity of the plurality of data tones, or a quantity of carrier frequency offset tracking tones.

27. The wireless communication device of claim 26, wherein the second scaling factor is in accordance with an inverse of the quantity of the plurality of data tones divided by the total quantity of tones in the RU.

28. The wireless communication device of claim 21, wherein the one or more fields of the preamble portion communicated according to the first per-tone transmit power comprise a long training field.

29. The wireless communication device of claim 28, wherein, to receive the data portion of the PPDU, one or more per-tone channel estimations obtained using the long training field are scaled according to a scaling factor in accordance with the long training field being communicated according to the first per-tone transmit power, and the second per-tone transmit power is scaled relative to the first per-tone transmit power by the scaling factor.

30. The wireless communication device of claim 21, wherein an average power of each symbol to communicate the data portion is equal to an average power of each symbol to transmit the one or more fields of the preamble portion in accordance with the plurality of pilot tones corresponding to the null-tone value.
